(19) United States
(12) Patent Application Publication
(10) Pub. No.: US 2023/0360393 A1
(43) Pub. Date: Nov. 9, 2023

(54) METHOD AND DEVICE OF ALTERING SPECTRAL DATA CUBE

(71) Applicant: Panasonic Intellectual Property Management Co., Ltd., Osaka (JP)

(72) Inventors: MOTOKI YAKO, Osaka (JP); YUMIKO KATO, Osaka (JP)

(21) Appl. No.: 18/353,883

(22) Filed: Jul. 18, 2023

Related U.S. Application Data
(63) Continuation of application No. PCT/JP2022/001493, filed on Jan. 18, 2022.

(30) Foreign Application Priority Data
Feb. 3, 2021 (JP) 2021-016153
Dec. 15, 2021 (JP) 2021-203149

(51) Int. Cl. G06V 20/10; G06T 3/40; G06T 5/50; G06T 9/00; H04N 23/75

(52) U.S. Cl. CPC G06V 20/194; G06T 3/40; G06T 5/50; G06T 9/00; H04N 23/75; G06T 2207/10036

(57) ABSTRACT

A method executed by a computer includes obtaining matrix data representing an encoding matrix used to encode a spectral data cube including image information in wavelength bands and to generate a compressed image and/or a decoding matrix used to generate the spectral data cube by decoding from the encoded compressed image, editing the matrix data in a way of causing the image information in at least one of the wavelength bands in the spectral data cube to be altered in the spectral data cube after being generated by decoding, and outputting the matrix data after the editing.

### BACKGROUND

### 1. Technical Field

The present disclosure relates to a method and a device of altering a spectral data cube.

### 2. Description of the Related Art

By utilizing spectral information regarding many wavelength bands, for example, ten or more bands, each being a narrow band, detailed physical properties of a target can be grasped which have been impossible to grasp with a known RGB image including information of only three bands. There are, for example, a “hyperspectral camera” and a “multispectral camera” as cameras for obtaining an image of so many wavelength bands. Those cameras are used in various fields, such as food inspection, biological examination, development of pharmaceuticals, and component analyses of minerals. Detailed spectral information of targets can be obtained by taking images of the targets with those cameras. The spectral information includes information featuring materials, states, or types of the targets. Therefore, encoding or encryption of the spectral information is demanded in some cases from the viewpoint of security protection or data confidentiality.

U.S. Pat. No. 9,599,511 discloses an example of a hyperspectral imaging device utilizing compressed sensing. The disclosed imaging device includes an encoding element in the form of an array of two-dimensionally arranged optical filters, an image sensor that detects light after transmitting through the encoding element, and a signal processing circuit. The encoding element is disposed on an optical path connecting a subject and the image sensor. Transmission spectra of the filters in the encoding element are different per filter. The image sensor obtains one two-dimensional image by simultaneously detecting, for each pixel, light in which components of wavelength bands after transmitting through the filters are superimposed. Such a two-dimensional image is referred to as a “compressed image” in this specification. The signal processing circuit generates an image by decoding for each of the wavelength bands by applying the compressed sensing to the obtained compressed image with use of matrix data representing a spatial distribution of the transmission spectra of the encoding element. Thus, U.S. Pat. No. 9,599,511 discloses a technique for encoding or encrypting the spectral information of the target by using the encoding element at the time of taking the image.

Japanese Unexamined Patent Application Publication (Translation of PCT Application) No. 2020-508623 discloses an example of a technique of encoding and compressing data, such as a multispectral image or a hyperspectral image, after taking the image.

Japanese Unexamined Patent Application Publication No. 2007-180710 discloses an example of a technique of embedding an electronic watermark data into unicolor data in a multicolor image data.

### SUMMARY

One non-limiting and exemplary embodiment provides a novel method of executing an alteration, for example, an insertion of an identifier into a spectral data cube, such as a hyperspectral image or a multispectral image.

In one general aspect, the techniques disclosed here feature a method executed by a computer. The method includes obtaining matrix data representing an encoding matrix used to encode a spectral data cube including image information in wavelength bands and to generate a compressed image and/or a decoding matrix used to generate the spectral data cube by decoding from the encoded compressed image, editing the matrix data in a way of causing the image information in at least one of the wavelength bands in the spectral data cube to be altered in the spectral data cube after being generated by decoding, and outputting the matrix data after the editing.

According to the one aspect of the present disclosure, when the spectral data cube is encoded or generated by decoding, the image information in the at least one wavelength band in the spectral data cube is altered. This can make the content of the spectral data cube confidential or can increase traceability in case of fraudulent leakage of the spectral data cube. It is also possible to change in a pseudo manner characteristics of an imaging device for obtaining the compressed image.

It should be noted that general or specific embodiments of the present disclosure may be implemented as a system, a device, a method, an integrated circuit, a computer program, a computer-readable recording medium, or any selective combination thereof. The computer-readable recording medium includes a nonvolatile recording medium, such as a CD-ROM (Compact Disc-Read Only Memory). The device may be constituted by one or more devices. When the device is constituted by two or more devices, those two or more devices may be disposed within one apparatus or may be separately disposed within two or more separate apparatuses. The word “device” used in this Specification and Claims may indicate not only one device, but also a system made up of devices.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is an explanatory view of a method of inserting an identifier into a spectral data cube;

FIG. 2A illustrates an example of editing of matrix data;

FIG. 2B illustrates another example of the editing of the matrix data;

FIG. 2C illustrates still another example of the editing of the matrix data;

FIG. 3A is a schematic view illustrating an example of configuration of a hyperspectral imaging system;

FIG. 3B is a schematic view illustrating a first modification of the hyperspectral imaging system;

FIG. 3C is a schematic view illustrating a second modification of the hyperspectral imaging system;

FIG. 3D is a schematic view illustrating a third modification of the hyperspectral imaging system;

FIG. 4A is a schematic view illustrating an example of a filter array;

FIG. 4B illustrates an example of a spatial distribution of light transmittance for each of wavelength bands included in a target wavelength range;

FIG. 4C illustrates an example of spectral transmittance in a region A1 included in the filter array of FIG. 4A;

FIG. 4D illustrates an example of spectral transmittance in a region A2 included in the filter array of FIG. 4A;

FIG. 5A is an explanatory view illustrating a relation between a target wavelength range and wavelength bands included in the target wavelength range;

FIG. 5B is an explanatory view illustrating a relation between a target wavelength range and wavelength bands included in the target wavelength range;

FIG. 6A is an explanatory view illustrating characteristics of spectral transmittance in a certain region of the filter array;

FIG. 6B illustrates a result of averaging the spectral transmittance, illustrated in FIG. 6A, for each wavelength band;

FIG. 7 illustrates an example of configuration of an inspection system according to a first embodiment;

FIG. 8 is a block diagram illustrating an example of configuration related to data processing in the inspection system;

FIG. 9 is an explanatory view of an identifier insertion process in the first embodiment;

FIG. 10A is a flowchart illustrating an example of processing in a processing circuit;

FIG. 10B is a flowchart illustrating an example of a process of editing a decoding table in accordance with the identifier;

FIG. 11 is an explanatory view of an identifier insertion process in a second embodiment;

FIG. 12 is an explanatory block diagram of the identifier insertion process in the second embodiment;

FIG. 13 is a block diagram illustrating a configuration of a system according to a third embodiment;

FIG. 14 is a block diagram illustrating a configuration of a system according to a fourth embodiment;

FIG. 15 is a block diagram illustrating a configuration of an inspection system according to a fifth embodiment;

FIG. 16 is a block diagram illustrating a modification of the inspection system according to the fifth embodiment;

FIG. 17 is a block diagram illustrating a configuration of a system according to a sixth embodiment; and

FIG. 18 is a block diagram illustrating a configuration of a system according to a seventh embodiment.

### DETAILED DESCRIPTIONS

It is to be noted that any embodiments described below represent general or specific examples. Numerical values, shapes, materials, constituent elements, layouts and positions of and connection forms between the constituent elements, steps, order of the steps, which are described in the following embodiments, are merely illustrative, and they are not purported to limit the technique of the present disclosure. Ones of the constituent elements in the following embodiments, those ones being not stated in independent claims representing the most significant concept, are explained as optional constituent elements. Furthermore, the drawings are schematic views and are not always exactly drawn in a strict sense. In the drawings, substantially the same or similar constituent elements are denoted by the same reference signs. Duplicate description is omitted or simplified in some cases.

In the present disclosure, all or part of circuits, units, devices, members, or portions, or all or part of functional blocks in block diagrams may be executed, for example, by one or more electronic circuits including a semiconductor device, a semiconductor integrated circuit (IC), or an LSI (large scale integration). The LSI or the IC may be integrated on one chip or constituted in combination of chips. For example, functional blocks other than a storage element may be integrated into one chip. While the word “LSI” or “IC” is used here, names of circuits change depending on a degree of integration, and the so-called system LSI, VLSI (very large scale integration), or ULSI (ultra large scale integration) may also be used. An FPGA (Field Programmable Gate Array) programmed after manufacturing of an LSI or a RLD (reconfigurable logic device) enabling connection relations inside an LSI to be reconfigured or circuit partitions inside an LSI to be set up can be further used for the same purpose.

In addition, functions or operations of all or part of circuits, units, devices, members, or portions can be executed with software processing. In this case, software is recorded on one or more non-temporary recording mediums, such as ROMs, optical disks, or hard disk drives, and when the software is executed by a processing device, functions specified by the software are executed by the processing device and peripheral devices. A system or a device may include one or more non-temporary recording mediums on which the software is recorded, the processing device, and a necessary hardware device such as an interface.

### Underlying Knowledge Forming Basis of the Present Disclosure

An imaging device, such as a hyperspectral camera or a multispectral camera, can obtain image information in a larger number of wavelength bands than an ordinary camera that obtains an RGB image. Image data obtained by those cameras is referred to as a “spectral data cube” or simply “data cube” in this specification. Particularly, data representing a hyperspectral image obtained by the hyperspectral camera is referred to as a “hyperspectral data cube” or “HS data cube”. The spectral data cube includes image information for each of wavelength bands. The spectral data cube includes important information featuring materials, states, or types of targets. Accordingly, the spectral data cube is required to be handled under strict control. There is a possibility that a data cube generated in a product inspection process, for example, may be fraudulently brought out or leaked to the outside. Hence the data cube is required to be altered and made confidential in some cases. The data cube may also be made traceable in consideration of the event of fraudulent leakage. For that purpose, embedding an identifier, such as an electronic watermark, into data is conceivable as one solution. An example of a conceivable countermeasure is to embed an identifier for specifying a camera or an inspection device that has been used to generate the data cube of interest, or an identifier for specifying the date and time when the data cube of interest has been generated.

However, the related art has a possibility of leakage of the data cube in a not-altered state because a step of generating the data cube and a step of performing the alteration, such as the insertion of the identifier into the data cube, are separated from each other. For example, there is a possibility that, in the product inspection process using the hyperspectral camera, a worker or a malicious third party may fraudulently bring out or leak the HS data cube before the alteration to the outside.

The inventors have found the above-described problems and have succeeded in achieving the following embodiments of the present disclosure. The embodiments of the present disclosure are summarized below.

A method according to one aspect of the present disclosure is a signal processing method executed by a computer. The method includes (a) obtaining matrix data representing an encoding matrix used to encode a spectral data cube including image information in wavelength bands and to generate a compressed image and/or a decoding matrix used to generate the spectral data cube by decoding from the encoded compressed image, (b) editing the matrix data in a way of causing the image information in at least of the wavelength bands in the spectral data cube to be altered in the spectral data cube after being generated by decoding, and (c) outputting the matrix data after the editing.

Here, the term “compressed image” indicates image data in which the image information in the wavelength bands is compressed as one two-dimensional image. The compressed image can be generated by encoding the spectral data cube, generated by the imaging device such as the hyperspectral camera, in accordance with an encoding matrix. Alternatively, the compressed image can also be generated by the imaging device utilizing the compressed sensing, such as disclosed in U.S. Pat. No. 9,599,511.

The “spectral data cube” is data having three-dimensional values of two-dimensional coordinates (x, y) and a wavelength λ. The spectral data cube includes the image information for each of the wavelength bands. The number of wavelength bands in the spectral data cube is any number of greater than or equal to 4. The number of bands may be greater than or equal to 10 in an example and may be greater than or equal to 100 depending on the case. As the number of bands increases, information of a larger number of spectra can be obtained, and physical properties, characteristics, types, and so on of targets can be inspected in more detail.

The above-described method may be executed by, for example, a computer in an inspection system for inspecting products or a server computer for delivering data necessary for inspection to the computer in the inspection system. According to the above-described method, the matrix data representing the encoding matrix used to generate the compressed image and/or the decoding matrix used to generate the spectral data cube by decoding from the compressed image is edited in accordance with the specifics of the alteration to be made on the spectral data cube. More specifically, a value of one or more matrix elements in the matrix data representing the encoding matrix or the decoding matrix is rewritten to a value different from an original value in accordance with the specifics of the alteration. For example, in an application of embedding the identifier into the spectral data cube, a value of one or more particular matrix elements in the matrix data representing the encoding matrix or the decoding matrix is rewritten to a value different from an original value in accordance with the specifics of the identifier. On the other hand, in an application of making the content of the spectral data cube confidential, a value of part or all of the matrix elements in the matrix data may be rewritten to a value different from an original value, for example, such that random noise is superimposed on the spectral data cube.

When the encoding matrix is edited, the compressed image generated by using the encoding matrix is altered, and the spectral data cube generated by decoding is also altered consequently. On the other hand, when the decoding matrix is edited, the compressed image is not altered, but the spectral data cube generated by decoding is altered. In any case, the spectral data cube finally generated after decoding is altered in accordance with the specifics of editing of the matrix data.

According to the above-described method, since the spectral data cube before the alteration is not generated, the vulnerability of data security can be overcome. For example, reading the original spectral data cube can be made difficult for a third party who does not know the specifics of editing of the matrix data. Furthermore, with the identifier embedded in the spectral data cube, whether the spectral data cube is duly generated or fraudulently leaked can be discriminated.

The encoding matrix and the decoding matrix may be both edited as appropriate, and the alteration may be consequently performed, for example, such that an identifier is applied to the spectral data cube finally generated after decoding. In this case, the matrix data includes first matrix data representing the encoding matrix and second matrix data representing the decoding matrix, and editing the matrix data includes editing of the first matrix data and the second matrix data.

Editing the matrix data may include rewriting the matrix data such that the image information in the at least one wavelength band includes an identifier in the spectral data cube after being generated by decoding. In this case, the identifier is embedded in image data in the at least one wavelength band in the finally generated spectral data cube. With the embedding of the identifier, whether the spectral data cube is duly generated can be determined, and traceability in case of fraudulent leakage can be increased. The identifier may be embedded to be visually discernable by a person, or it may be embedded in a state not discernable by a person, but discernable by a computer, like steganographic information.

Editing the matrix data may include rewriting the matrix data such that noise hindering read of the image information in the at least one wavelength band is applied to the spectral data cube. Here, the “noise hindering read of the image information” indicates noise making it difficult for a person or a computer to recognize the original image information. Such noise may be applied to the image information in the wavelength bands in the spectral data cube. With the above-mentioned feature, the details of the original spectral data cube are made confidential, and hence vulnerability of data security can be overcome.

Editing the matrix data may include rewriting the matrix data in a way of causing the image information in the wavelength bands in the spectral data cube to be altered in the spectral data cube after being generated by decoding. Since the image information in the wavelength bands is altered, the effect of overcoming the vulnerability of the data security can be increased.

The above-described signal processing method may be used with intent not only to overcome the vulnerability of the data security, but also to change in a pseudo manner characteristics of the imaging device for obtaining the image data to generate the spectral data cube. For example, multiplying each matrix element of the decoding matrix, used to generate the spectral data cube by decoding from the compressed image obtained by the imaging device, by a constant can increase or decrease a dynamic range of the imaging device in a pseudo manner. In other words, editing the matrix data may include rewriting the matrix data such that a gradation of the image information in the at least one wavelength band is changed in the spectral data cube after being generated by decoding. Alternatively, noise of the imaging device can be made appear to increase in a pseudo manner by superimposing random noise on the decoding matrix. A resolution of the image taken by the imaging device can also be reduced in a pseudo manner by a process of, for example, averaging adjacent cells in the decoding matrix. In other words, editing the matrix data may include rewriting the matrix data such that the resolution of the image information in the at least one wavelength band is changed in the spectral data cube after being generated by decoding.

A device for editing the matrix data, a device for generating the compressed image, and a device for generating the spectral data cube by decoding may be different devices or the same device. For example, the imaging device or an inspection device for generating the compressed image may have both the function of editing the matrix data and the function of generating the spectral data cube by decoding. Alternatively, a signal processing device different from the imaging device or the inspection device for generating the compressed image may have both the function of editing the matrix data and the function of generating the spectral data cube by decoding.

In a certain embodiment, the matrix data represents the decoding matrix. In that case, the matrix data representing the decoding matrix is edited corresponding to the specifics of an alteration of the spectral data cube and is output. Thus, by using the matrix data after the editing, the altered spectral data cube can be generated by decoding.

Outputting the matrix data after the editing may include transmitting the matrix data to a device that generates the spectral data cube by decoding from the compressed image based on the matrix data representing the decoding matrix. The device may be the inspection device installed in a factory, for example. In that case, the edited matrix data may be delivered to and used in the inspection device.

Outputting the matrix data may include storing the matrix data representing the decoding matrix in a storage medium. The above-described method may further include obtaining the compressed image and generating the spectral data cube by decoding from the compressed image by using the matrix data after the editing.

The compressed image may be generated by an imaging device including a filter array. The filter array may include multiple types of optical filters with transmission spectra different from one another. The multiple types of optical filters may be arrayed in a two-dimensional plane. The encoding matrix corresponds to a two-dimensional distribution of the transmission spectra of the filter array. Stated another way, a matrix representing the two-dimensional distribution of the transmission spectra of the filter array may be used as the encoding matrix. In that configuration, generating the image data in accordance with light having transmitted through the filter array by the imaging device corresponds to encoding the spectral data cube by using the encoding matrix and generating the compressed image. Generating the spectral data cube by decoding may include generating the spectral data cube by decoding from the compressed image with a compressed sensing process based on the decoding matrix. With that feature, because of utilizing the compressed sensing, the spectral data cube can be generated by decoding with higher accuracy from the compressed image which has been encoded by using the filter array corresponding to the encoding matrix.

The compressed image may be generated by not only the above-described imaging device including the filter array, but also a device with a different structure. For example, the compressed image may be generated by executing an encoding process based on the encoding matrix on the spectral data cube that has been generated by another imaging device such as a hyperspectral camera. Such a configuration may be adopted, for example, in the case in which the spectral data cube needs to be compressed to reduce the data size for the purpose of recording the spectral data cube on the storage medium or transmitting the spectral data cube via a communication circuit.

In a certain embodiment, the matrix data represents the encoding matrix. In that case, the matrix data representing the encoding matrix is edited in accordance with the specifics of an alteration of the spectral data cube and is then output. Thus, the altered compressed image can be generated by using the matrix data after the editing, and the altered spectral data cube can be generated consequently.

Outputting the matrix data may include transmitting the matrix data to a device that generates the compressed image by encoding the spectral data cube based on the matrix data representing the encoding matrix. With that feature, the device generating the compressed image can generate the altered compressed image by using the edited encoding matrix. The altered spectral data cube can be generated by using the altered compressed image and the decoding matrix.

Outputting the matrix data after the editing may include storing the matrix data representing the encoding matrix in a storage medium. The above-described method may further include obtaining the spectral data cube and generating the compressed image by encoding the spectral data cube based on the matrix data after the editing. With that feature, the altered compressed image can be generated. The altered spectral data cube can be generated by using the altered compressed image and the decoding matrix.

When the spectral data cube is altered to include the identifier, the identifier may include information specifying a device that generates the compressed image based on the encoding matrix, or a device that generates the spectral data cube by decoding based on the decoding matrix. The identifier may include information specifying the date and time of application of the identifier. With the identifier including that information, the traceability of the spectral data cube can be increased.

Obtaining the matrix data may include obtaining a decoding table to generate an image by decoding from the compressed image for each of wavelength bands included in a target wavelength range, and generating, based on the decoding table, as the matrix data representing the decoding matrix, a reduced decoding table in which two or more wavelength bands among the wavelength bands are unified into one wavelength band and which is used to generate, as the spectral data cube, an image by decoding for each of a smaller number of wavelength bands than all the wavelength bands. Editing the matrix data may include editing the reduced decoding table. Since the reduced decoding table is generated as the matrix data, a calculation load in a decoding process can be reduced. The above-described processing is especially effective, for example, when it is just enough to be able to obtain the image information in a smaller number of bands each having a relatively wide band width.

Outputting the matrix data after the editing may include transmitting the reduced decoding table after the editing to another device. With this feature, the other device can generate the altered spectral data cube by decoding from the compressed image with a low calculation load in accordance with the reduced decoding table after the editing.

A device according to another aspect of the present disclosure includes a storage and a processing circuit. The storage stores matrix data representing an encoding matrix used to encode a spectral data cube including image information in wavelength bands and to generate a compressed image and/or a decoding matrix used to generate the spectral data cube by decoding from the encoded compressed image. The processing circuit edits the matrix data in a way of causing the image information in at least one of the wavelength bands in the spectral data cube to be altered in the spectral data cube after being generated by decoding, and outputs the matrix data after the editing. The above-described device can overcome, for example, the vulnerability of the security attributable to the generation or transmission of the spectral data cube not altered. The above-described device may be, for example, an inspection device for inspecting products or a server computer that delivers the matrix data to the inspection device. The above-described device may be used with intent not only to overcome the vulnerability of the security, but also to change in a pseudo manner, for example, characteristics of the imaging device for obtaining the compressed image.

A device according to still another aspect of the present disclosure includes a storage that stores the matrix data after the editing, the matrix data being output from the above-described device editing the matrix data, and a processing circuit that executes a process of encoding the spectral data cube based on the matrix data and generating the compressed image and/or a process of generating the spectral data cube by decoding from the compressed image based on the matrix data. The above-described device can generate the altered compressed image or the altered spectral data cube based on the matrix data after the editing.

The matrix data may represent the decoding matrix. The above-described device may further include an imaging device that generates the compressed image. The processing circuit may generate the spectral data cube by decoding from the compressed image based on the matrix data representing the decoding matrix. With that feature, the altered spectral data cube can be generated.

The imaging device may include a filter array including multiple types of optical filters with transmission spectra different from one another, and an image sensor that detects light transmitting through the filter array and generates the compressed image. The encoding matrix corresponds to a two-dimensional distribution of the transmission spectra of the filter array. With the above-described imaging device, the compressed image in which spectral information of a target is compressed as a two-dimensional image can be obtained. The spectral data cube for the target can be generated based on the compressed image and the matrix data representing the decoding matrix.

The method of altering the data cube will be described in more detail below with reference to the drawings. In the following, an example of a method inserting the identifier into the data cube is described as one example of the method of altering the data cube.

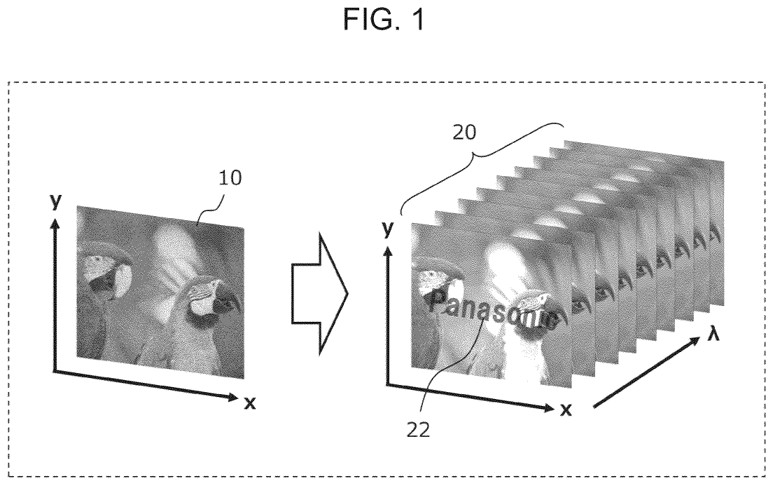

FIG. 1 is an explanatory view of the method of inserting the identifier into the spectral data cube. In an embodiment of the present disclosure, a data cube 20 including image information for each of wavelength bands of more than or equal to 4 (9 in the example of FIG. 1) is generated from one compressed image 10. The compressed image 10 is data in which the image information in the wavelength bands is compressed as a monochromatic image. The compressed image 10 may be generated by a hyperspectral camera utilizing the compressed sensing (hereinafter also referred to as a “compressive HS camera”), such as disclosed in U.S. Pat. No. 9,599,511, for example. The compressive HS camera includes a filter array in which multiple types of optical filters with different transmission spectra are arrayed in a two-dimensional plane, and an image sensor that obtains an image of light after transmitting through the filter array. A filter in at least part of the filter array may have such characteristics that a transmittance locally increases in at least two among narrow bands included in a preset target wavelength range. A two-dimensional distribution of the transmission spectra in the filter array is determined in accordance with a predetermined encoding matrix. Each filter in the filter array modulates the intensity of incident light at a different transmittance for each wavelength. The above-mentioned filter array is referred to as an “encoding element”. The compressed image 10 may be generated by a device different from the compressive HS camera. For example, a data processing device may generate the compressed image 10 by encoding, with an encoding matrix, a data cube that is generated by any suitable hyperspectral camera or multispectral camera. The data cube 20 is generated from the compressed image 10 through a decoding process using a decoding matrix corresponding to the encoding matrix. The compressed sensing technique, such as disclosed in U.S. Pat. No. 9,599,511, for example, may be used for the decoding process.

In the embodiment illustrated in FIG. 1, at least one of the encoding matrix and the decoding matrix is edited in accordance with the specifics of an identifier 22 such that the identifier 22 is included in the decoded data cube 20. This enables the identifier 22 to be automatically added to the compressed image 10 or the data cube 20 by executing an encoding process or the decoding process.

When the identifier is inserted into the data cube by using the related art, it is required to, after obtaining the data cube before the insertion of the identifier, separately insert the identifier into the obtained data cube. Therefore, the data cube into which the identifier is not inserted is generated or transferred, and this indicates that a state in which data security is not safe may occur. By contrast, in this embodiment, the identifier 22 is inserted at the same time as when the compressed image 10 or the data cube 20 is generated. Thus, since the data cube into which the identifier is not inserted is not generated or transferred, the data security is superior to that in the relation art.

While the identifier 22 illustrated in FIG. 1 is character information that is visually discernable by a person, the identifier may be another type of information in the form of, for example, numerals or symbols. The identifier may also be steganographic information or the like that is difficult to visually discern but can be decrypted by a computer. A character “Panasonic” illustrated in FIG. 1 is an example of the identifier 22.

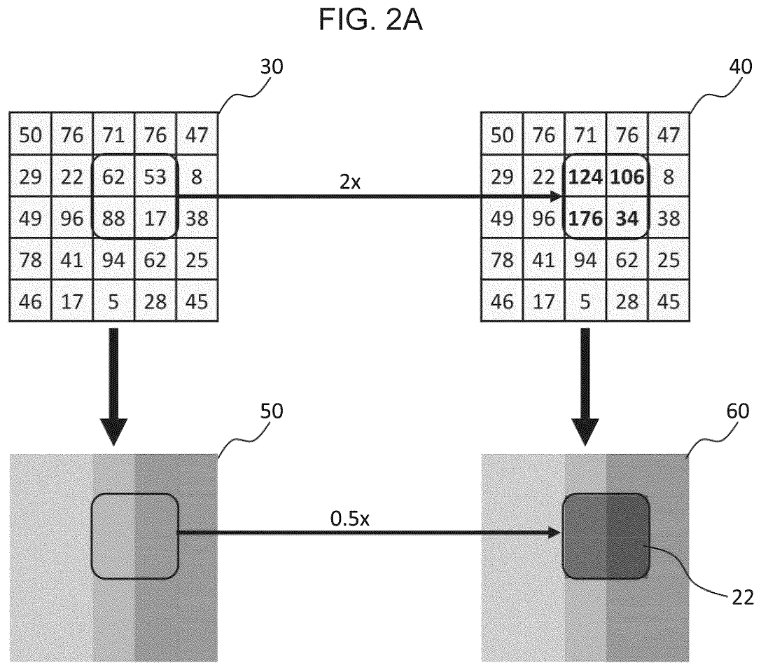

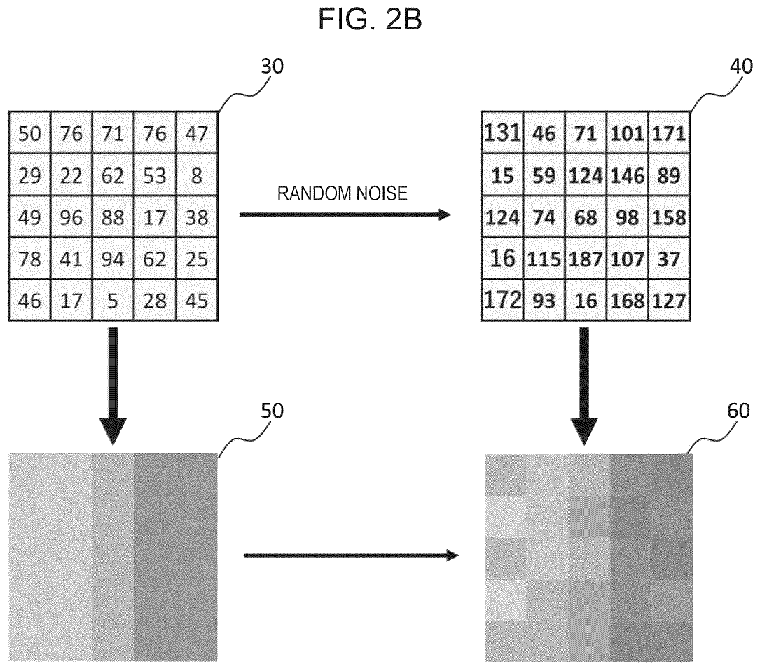

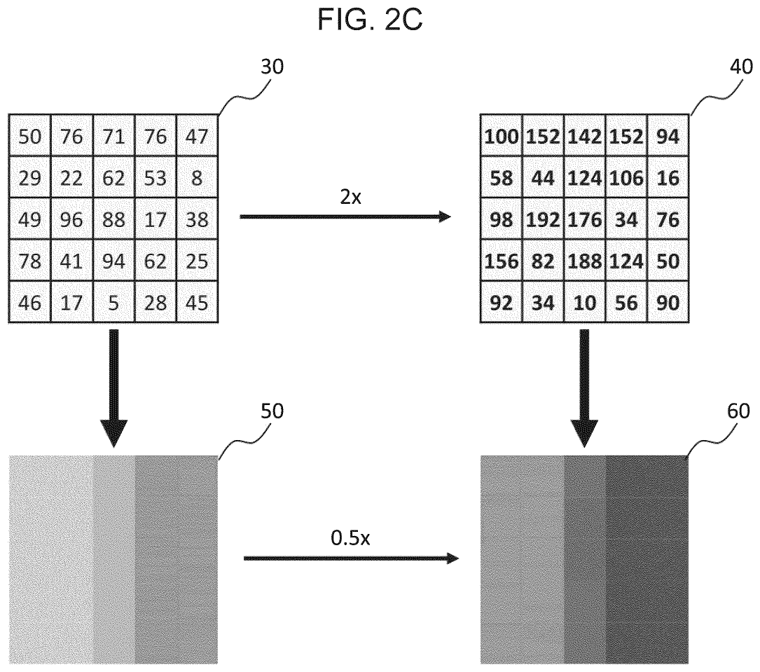

FIG. 2A illustrates an example of editing of matrix data. An example of the case of editing matrix data representing the decoding matrix is described here. In the following description, the matrix data representing the encoding matrix is referred to as an “encoding table”, and matrix data representing the decoding matrix is referred to as a “decoding table”. FIG. 2A illustrates an example of numerical values in part of the encoding table 30 and an example of numerical values in part of the decoding table 40. FIG. 2A further illustrates an example of a decoded image 50 in one band, the decoded image 50 being generated by decoding performed by using the same table as the encoding table 30, and an example of a decoded image 60 in the one band, the decoded image 60 being generated by decoding performed by using the edited decoding table 40.

As disclosed in U.S. Pat. No. 9,599,511, for example, the decoding into the data cube is performed by executing calculation such that the product resulting from applying the decoding matrix to a vector representing the data cube substantially matches with a vector representing a compressed image. Accordingly, when a value of a certain region of the decoding table 40 is increased n times (twice in the example of FIG. 2A) that in the encoding table 30, a brightness value of the decoded image 60 in the same region is calculated to become 1/n time an original brightness value of the decoded image 50. Thus, the decoding matrix can be edited such that a certain region has a brightness value smaller than or greater than an original brightness value of the decoded image 50. As a result of executing the above-described processing, the identifier 22 can be inserted into the spectral data cube at the same time as the spectral data cube is generated. Similar processing can also be executed for the encoding matrix. By rewriting values in partial regions of the encoding matrix and/or the decoding matrix in accordance with the specifics of the identifier 22, the desired identifier 22 can be inserted into the spectral data cube.

The above-described editing of the matrix data is not limited to the case of inserting the identifier 22 into the spectral data cube and may be further applied to the case of altering the spectral data cube in another way. As illustrated in a schematic view of FIG. 2B, for example, random noise may be applied to the spectral data cube after the decoding by rewriting matrix elements of at least one of the encoding matrix and the decoding matrix at random. Such an alteration can make the spectral data cube difficult to read and can make the information confidential.

In addition, specifications of the imaging device can be edited in a pseudo manner by using the method according to the present disclosure. Editing the matrix data is equivalent to editing characteristics of the image sensor in a pseudo manner. As illustrated in FIG. 2C, for example, multiplying each matrix element of the decoding matrix by a constant is equivalent to multiplying each pixel value of a taken compressed image by the reciprocal of the constant. Therefore, a dynamic range of the image sensor can be increased or decreased in a pseudo manner by multiplying each matrix element of the decoding matrix by a constant. In other words, a gradation of image information in the at least one wavelength band can be changed by rewriting the matrix data. Noise of the compressed image can be made appear to increase in a pseudo manner by superimposing random noise on the decoding matrix. A resolution of the image taken by the imaging device can also be reduced in a pseudo manner by a process of, for example, averaging adjacent pixels in the compressed image and the decoding matrix. In other words, the resolution of the image information in the at least one wavelength band can be changed by rewriting the matrix data.

Exemplary embodiments of the present disclosure on the basis of the above-described principle will be described in more detail below.

### FIRST EMBODIMENT

First, an example of configuration of a hyperspectral imaging system used in the first embodiment of the present disclosure is described. After the description of the configuration, an example of an inspection system utilizing the hyperspectral imaging system is described.

### Hyperspectral Imaging System

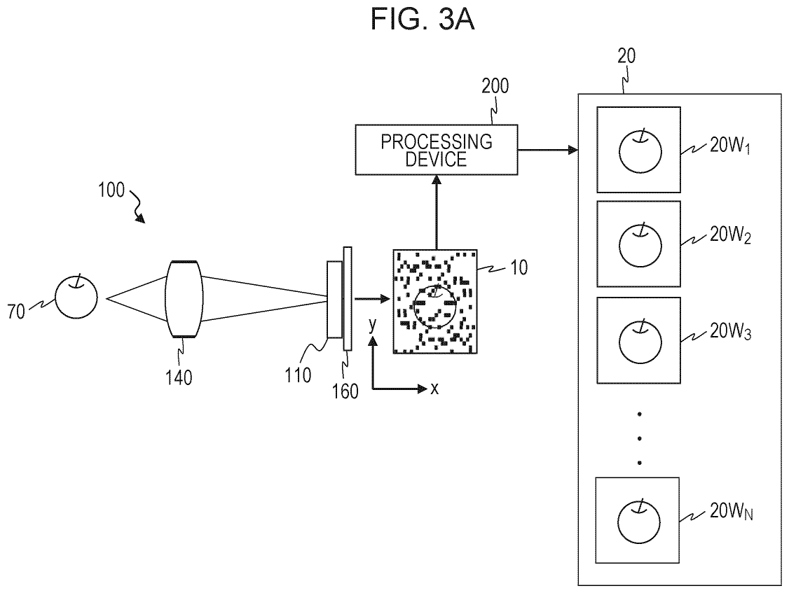

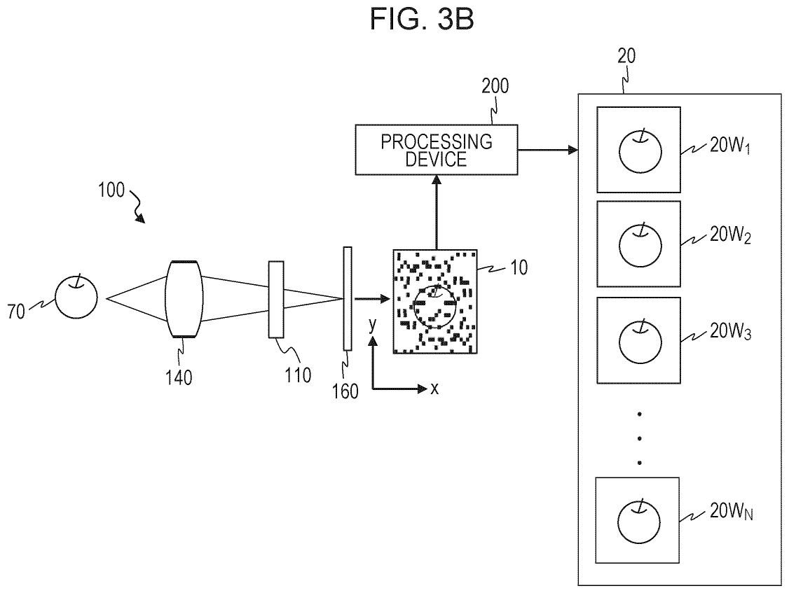

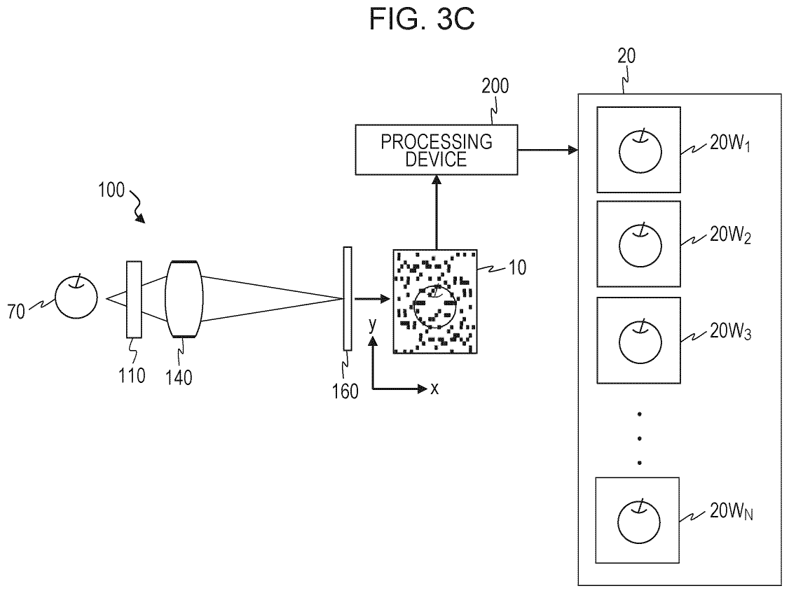

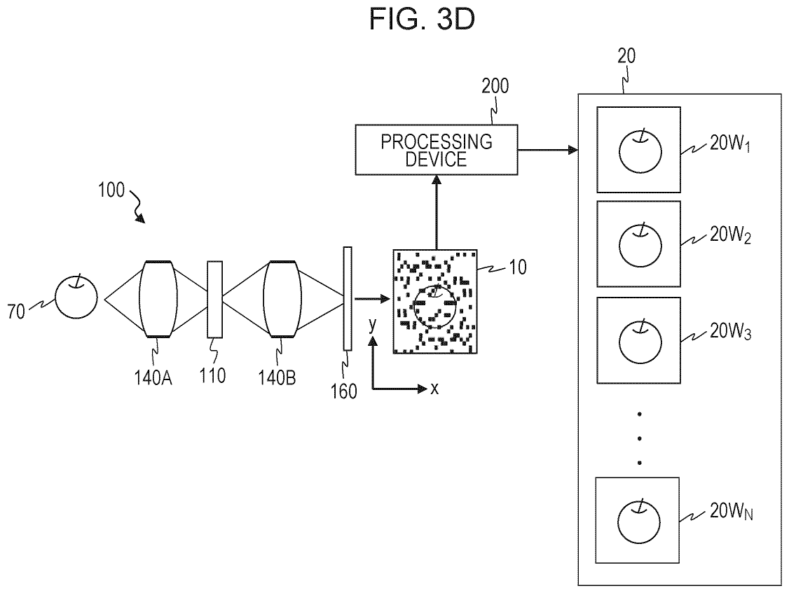

FIG. 3A is a schematic view illustrating the example of configuration of the hyperspectral imaging system. The hyperspectral imaging system includes an imaging device 100 and a processing device 200. The imaging device 100 has a similar configuration to that of the imaging device disclosed in U.S. Pat. No. 9,599,511. The imaging device 100 includes an optical system 140, a filter array 110, and an image sensor 160. The optical system 140 and the filter array 110 are disposed on an optical path of light incoming from a target 70 as a subject. The filter array 110 is disposed between the optical system 140 and the image sensor 160.

FIG. 3A illustrates an apple as an example of the target 70. The target 70 is not limited to the apple and may be any suitable object that can become an inspection target. The image sensor 160 generates data of the compressed image 10 in which the information in the wavelength bands is compressed as a two-dimensional monochromatic image. The processing device 200 generates image data for each of the wavelength bands included in the target wavelength range based on the data of the compressed image 10 generated by the image sensor 160. The image data in the wavelength bands, generated as described above, is referred to as the “hyperspectral (HS) data cube” or “hyperspectral image data”. It is here assumed that the number of wavelength bands included in the target wavelength range is N (N is an integer of greater than or equal to 4). In the following description, the generated image data in the wavelength bands are referred to as decoded images 20W₁, 20W₂, . . . , 20W_{N} and are collectively called a “hyperspectral image 20” or a “hyperspectral data cube 20”. In this specification, data or signals representing an image, namely a set of data or signals representing pixel values of individual pixels, is referred to simply as an “image” in some cases.

The filter array 110 is an array of filters being transparent and arrayed in rows and columns. The filters include multiple types of filters with transmission spectra (also called “spectral transmittances”), namely wavelength dependences of light transmittance, different from one another. The filter array 110 modulates the intensity of incident light per wavelength and outputs the modulated light. This process performed by the filter array 110 is referred to as “encoding” in this specification, and the filter array 110 is referred to as an “encoding element”.

In the example illustrated in FIG. 3A, the filter array 110 is disposed in the vicinity or the close vicinity of the image sensor 160. Here, the word “vicinity” indicates that the filter array 110 is positioned close enough to form the image of the light incoming from the optical system 140 on a surface of the filter array 110 with a certain degree of clarity. The wording “close vicinity” indicates that the filter array 110 and the image sensor 160 are positioned close to such an extent as causing substantially no gap between them. The filter array 110 and the image sensor 160 may be integrated with each other.

The optical system 140 includes at least one lens. While the optical system 140 is illustrated as one lens in FIG. 3A, it may be a combination of lenses. The optical system 140 forms an image on an imaging surface of the image sensor 160 through the filter array 110.

The filter array 110 may be disposed away from the image sensor 160. FIGS. 3B to 3D illustrate examples of configuration of the imaging device 100 in which the filter array 110 and the image sensor 160 are disposed away from each other. In the example of FIG. 3B, the filter array 110 is disposed at a position between the optical system 140 and the image sensor 160, the position being away from the image sensor 160. In the example of FIG. 3C, the filter array 110 is disposed between the target 70 and the optical system 140. In the example of FIG. 3D, the imaging device 100 includes two optical systems 140A and 140B, and the filter array 110 is disposed between those two optical systems. As in the above-described examples, the optical system including one or more lenses may be disposed between the filter array 110 and the image sensor 160.

The image sensor 160 is a monochromatic photodetector including light detection elements (also called “pixels” in this specification) that are two-dimensionally arrayed. The image sensor 160 may be, for example, a CCD (Charge-Coupled Device), a CMOS (Complementary Metal Oxide Semiconductor) sensor, or an infrared array sensor. The light detection elements include, for example, photodiodes. The image sensor 160 is not always required to be a monochromatic sensor. In another example, the image sensor 160 may be a color sensor including an R/G/B, R/G/B/IR, or R/G/B/W filter. Use of the color sensor can increase an amount of information regarding wavelengths and can improve accuracy in reconstruction of the hyperspectral image 20. A wavelength range of the image to be taken can be optionally determined, and the wavelength range may be an ultraviolet, near-infrared, medium-infrared, or far-infrared wavelength range without being limited to a visible light wavelength range.

The processing device 200 is a computer including a processor and a storage medium such as a memory. The processing device 200 generates, based on the compressed image 10 obtained by the image sensor 160, data of the decoded images 20W₁, 20W₂, . . . , 20W_{N} including the information for each of the wavelength bands.

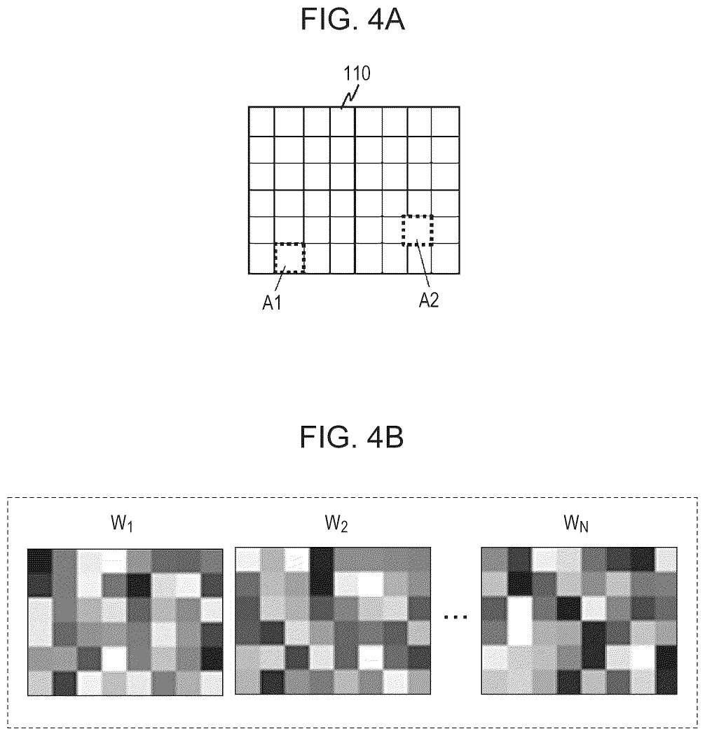

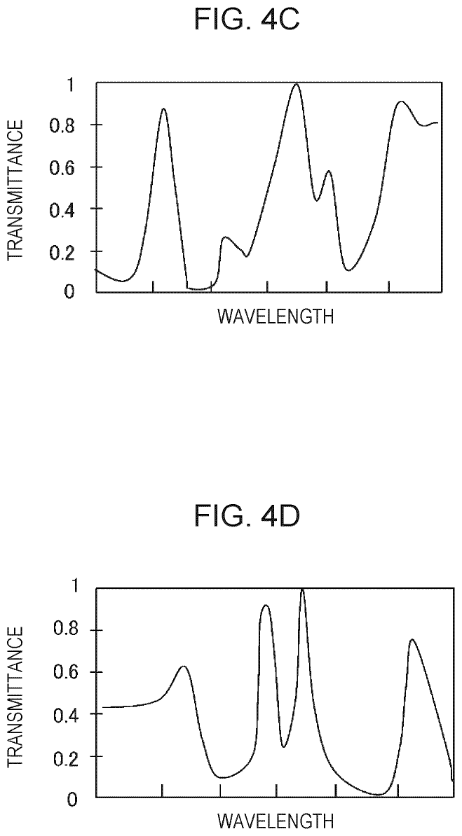

FIG. 4A is a schematic view illustrating an example of the filter array 110. The filter array 110 has two-dimensionally arrayed regions. In this specification, those regions are referred to as “cells” in some cases. In the regions, optical filters with individually set spectral transmittances are disposed. Assuming the wavelength of the incident light to be λ, the spectral transmittance is expressed by a function T(λ). The spectral transmittance T(λ) can take a value greater than or equal to 0 and smaller than or equal to 1.

In the example illustrated in FIG. 4A, the filter array 110 has 48 rectangular regions in an array of 6 rows and 8 columns. This example is merely illustrative, and a larger number of regions may be disposed in practical use. The number of the regions may be substantially equal to, for example, the number of pixels of the image sensor 160. The number of filters included in the filter array 110 may be determined in a range from tens to tens of millions depending on use.

FIG. 4B illustrates an example of a spatial distribution of light transmittance for each of the wavelength bands W₁, W₂, . . . , W_{N} included in the target wavelength range. In the example of FIG. 4B, a difference in light and dark levels among the regions represents a difference in transmittance. The transmittance is higher in a lighter region and is lower in a darker region. As illustrated in FIG. 4B, the spatial distribution of the light transmittance is different for each of the wavelength bands.

FIGS. 4C and 4D illustrate, respectively, examples of the spectral transmittances in regions A1 and A2 included in the filter array 110 of FIG. 4A. The spectral transmittance in the region A1 and the spectral transmittance in the region A2 are different from each other. Thus, the spectral transmittance of the filter array 110 is different per region. However, the spectral transmittances in all the regions are not always required to be different from one another. In the filter array 110, the spectral transmittances in at least part of the regions are different from one another. The filter array 110 includes two or more filters with different spectral transmittances. In an example, the number of patterns of the spectral transmittances in the regions included in the filter array 110 may be equal to or greater than the number N of the wavelength bands included in the target wavelength range. The filter array 110 may be designed such that the spectral transmittances are different in more than or equal to half of all the regions.

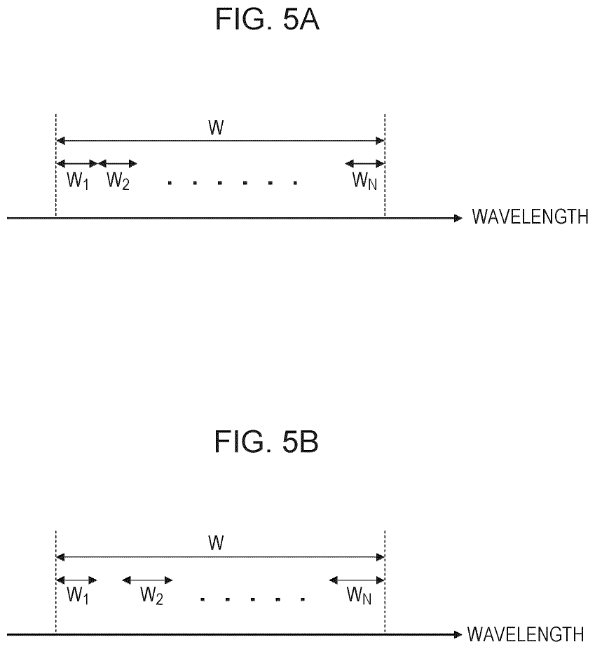

FIGS. 5A and 5B are each an explanatory view illustrating a relation between a target wavelength range W and the wavelength bands W₁, W₂, . . . , W_{N} included in the target wavelength range. The target wavelength range W may be set to any desired one from among various ranges depending on use. For example, the target wavelength range W may be a visible light wavelength range of longer than or equal to about 400 nm and shorter than or equal to about 700 nm, a near-infrared wavelength range of longer than or equal to about 700 nm and shorter than or equal to about 2500 nm, or a near-ultraviolet wavelength range of longer than or equal to about 10 nm and shorter than or equal to about 400 nm. Alternatively, the target wavelength range W may be, for example, a medium-infrared or far-infrared wavelength range. Thus, the wavelength range used is not limited to the visible light range. In this specification, the word “light” is used to indicate not only the visible light, but also the so-called radiations including infrared and ultraviolet rays.

In the example illustrated in FIG. 5A, assuming N to be an arbitrary integer of greater than or equal to 4, the target wavelength range W is divided into equal N ranges, and the divided ranges are set as the wavelength bands W₁, W₂, . . . , W_{N}. However, the wavelength bands are not limited to such an example. The wavelength bands included in the target wavelength range W may be set in any desired way. For example, the wavelength bands may have uneven band widths. Adjacent two of the wavelength bands may have a gap therebetween or may overlap each other. In the example illustrated in FIG. 5B, the band widths are different among the wavelength bands, and a gap is present between adjacent two of the wavelength bands. Thus, the wavelength bands just need to be different from one another, and a manner of dividing the target wavelength range is optional.

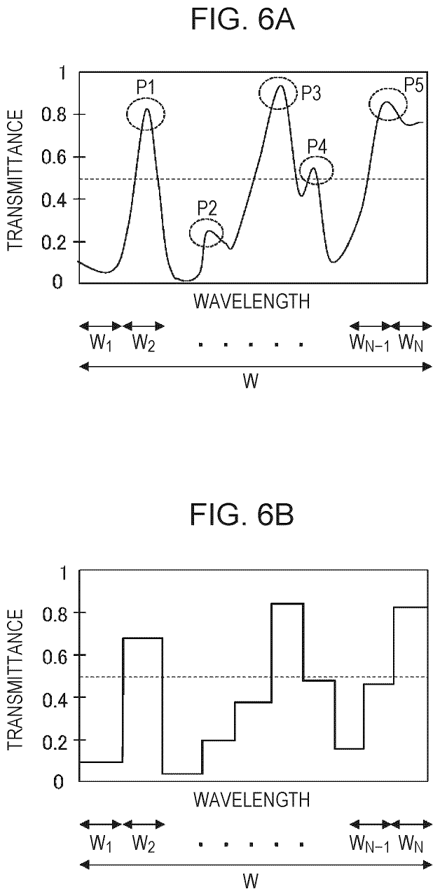

FIG. 6A is an explanatory view illustrating characteristics of the spectral transmittance in a certain region of the filter array 110. In the example illustrated in FIG. 6A, the spectral transmittance has local maximum values P1 to P5 and local minimum values with respect to wavelength in the target wavelength range W. In the example illustrated in FIG. 6A, the spectral transmittance in the target wavelength range W is normalized to have a maximum value of 1 and a minimum value of 0. In the example illustrated in FIG. 6A, the spectral transmittance has the local maximum values in several wavelength ranges, for example, the wavelength band W₂, the wavelength band W_{N-1}, and so on. Thus, the spectral transmittance in each region has local maximum values in at least two among the wavelength bands W₁ to W_{N}. In the example illustrated in FIG. 6A, the local maximum values P1, P3, P4, and P5 are greater than or equal to 0.5.

As described above, the light transmittance in each region is different depending on wavelength. Accordingly, the filter array 110 allows a component of the incident light in one wavelength range to transmit therethrough in a large amount, but does not allow a component of the incident light in another wavelength range to transmit therethrough in a so large amount. For example, the filter array 110 may have the transmittance of greater than 0.5 for the light in a number k of wavelength bands among the number N of wavelength bands and the transmittance of smaller than 0.5 for the light in a number (N−k) of the remaining wavelength bands. Here, k is an integer satisfying 2≤k<N. If the incident light is white light including evenly all wavelength components of visible light, the filter array 110 modulates the incident light into light having discrete intensity peaks with respect to wavelength for each of the regions, superimposes multiwavelength lights, and outputs the superimposed lights.

FIG. 6B is an explanatory view illustrating, by way of example, a result of averaging the spectral transmittance illustrated in FIG. 6A for each of the wavelength bands W₁, W₂, . . . , W_{N}. The averaged transmittance is obtained by integrating the spectral transmittance T(λ) per wavelength band and by dividing an integrated value by the band width of the wavelength band of interest. In this specification, a transmittance value averaged per wavelength band as described above is regarded as the transmittance in the wavelength band of interest. In the example illustrated in FIG. 6B, the transmittance is prominently high in three wavelength ranges where the transmittance takes the local maximum values P1, P3, and P5. Particularly, the transmittance exceeds 0.8 in two wavelength ranges where the transmittance takes the local maximum values P3 and P5.

In the examples illustrated in FIGS. 6A and 6B, a transmittance distribution of gray scale is supposed in which the transmittance in each region can take an arbitrary value of greater than or equal to 0 and smaller than or equal to 1. However, the transmittance distribution of the gray scale is not always needed. For example, a transmittance distribution of binary scale may be used in which the transmittance in each region can take one value of substantially 0 or substantially 1. In the transmittance distribution of the binary scale, each region allows most part of lights in at least two among the wavelength bands included in the target wavelength range to transmit therethrough, but does not allow most part of lights in the remaining wavelength bands to transmit therethrough. Here, the word “most part” indicates a percentage of greater than or equal to about 80%.

Part of all the cells, for example, a half of the cells, may be replaced with transparent regions. The transparent regions each allow the lights in all the wavelength bands W₁, to W_{N} included in the target wavelength range W to transmit therethrough at a substantially equal high transmittance, for example, a transmittance of higher than or equal to 80%. In such a configuration, the transparent regions may be arranged in, for example, a checkerboard pattern. Stated another way, in two array directions of the regions in the filter array 110, the region where the light transmittance is different depending on wavelength and the transparent region may be alternately arrayed.

Data representing the spatial distribution of the spectral transmittance of the filter array 110 described above is obtained in advance based on design data or calibration by actual measurement and is stored in the storage medium included in the processing device 200. The stored data is utilized in arithmetic processing described later.

The filter array 110 may be constituted by using, for example, a multilayer film, an organic material, a grating structure, or a metal-containing microstructure. When the multilayer film is used, it may be a multilayer film including a dielectric multilayer film or a metal layer. In this case, the multilayer film is formed such that at least one of thicknesses of individual layers of the multilayer film, materials thereof, and the order of laminating the individual layers is different per cell. This enables spectral characteristics different per cell to be realized. Using the multilayer film can realize sharp rise and fall in the spectral transmittance. The filter array using the organic material can be realized by forming the cells such that the individual cells contain different types of pigments or dyes, or by laminating different types of materials per cell. The filter array using the grating structure can be realized by forming a diffraction structure in which a diffraction pitch or depth is different per cell. When the metal-containing microstructure is used, the filter array can be fabricated by utilizing spectral dispersion due to the plasmon effect.

An example of signal processing executed by the processing device 200 will be described below. The processing device 200 reconstructs the multiwavelength hyperspectral image 20 based on both the compressed image 10 output from the image sensor 160 and spatial distribution characteristics of the transmittance of the filter array 110 for each wavelength. Here, the term “multiwavelength” indicates a larger number of wavelength bands than three-color wavelength bands of RGB obtained by an ordinary color camera, for example. The number of the wavelength bands may be, for example, a number of about in a range of 4 to 100. The number of the wavelength bands is referred to as a “band number”. The band number may exceed 100 depending on use.

Data to be obtained is data of the multiwavelength hyperspectral image 20, and that data is assumed to be f Assuming the band number to be N, f is data resulting from integrating image data f₁, f₂, . . . , f_{N} of the individual bands. Here, as illustrated in FIG. 3A, the horizontal direction of the image is assumed to be an x-direction, and the horizontal direction of the image is assumed to be a y-direction. On an assumption that the number of pixels of the image data to be obtained in the x-direction is n and the number of pixels in the y-direction is m, the image data f₁, f₂, . . . , f_{N} are each two-dimensional data of n×m pixels. Accordingly, the data f is three-dimensional data with the number of elements of n×m×N. That three-dimensional data is referred to as the “hyperspectral image data” or the “hyperspectral data cube”. On the other hand, the number of elements of data g of the compressed image 10 obtained by the filter array 110 through encoding or multiplexing is n×m. The data g can be expressed by the following formula (1):

$$g = Hf = H [ \begin{matrix}{f}_{1} \\ {f}_{2} \\ ⋮ \\ {f}_{N}\end{matrix} ] \qquad ( 1 )$$

In the formula (1), f₁, f₂, . . . , f_{N} are each data with the (n×m) elements. Strictly speaking, a vector on the right side is a one-dimensional vector of (n×m×N) rows and one column. The vector g is a one-dimensional vector having (n×m) rows and one column. A matrix H represents conversion of encoding and intensity-modulating the individual components f₁, f₂, . . . , f_{N} of the vector fin accordance with encoding information (hereinafter also referred to as “mask information”) that is different for each wavelength band, and then adding the results. Thus, H is a matrix of (n×m) rows and (n×m×N) columns.

It seems that, if the vector g and the matrix H are given, f can be calculated by solving the inverse problem of the equation (1). However, because the number of elements (n×m×N) of the data f to be obtained is more than the number of elements (n×m) of the obtained data g, the problem of interest is an ill-posed problem and cannot be solved as it is. Accordingly, the processing device 200 finds the solution with a compressed sensing method by utilizing redundancy of the image included in the data f. More specifically, the data f to be obtained is estimated by solving the following equation (2):

$${f}^{′} = {arg min}_{f} \{ {‖ g - Hf ‖}_{{l}_{2}} + τ Φ ( f ) \} \qquad ( 2 )$$

In the formula (2), f′ represents estimated data off. The first term in the parenthesis in the above formula represents a deviation between an estimated result Hf and the obtained data g, namely the so-called residual term. While the sum of squares is used as the residual term here, an absolute value, the square root of sum of squares, or the like may also be used as the residual term. The second term in the parenthesis represents a regularization term or a stabilization term. The formula (2) indicates that f minimizing the sum of the first term and the second term is to be found. The processing device 200 can calculate the final solution f by converging the solution through recursive iteration.

The first term in the parenthesis in the formula (2) indicates an operation of calculating the sum of squares of differences between the obtained data g and Hf resulting from converting fin an estimation process with the matrix H. Φ(f) in the second term represents a constraint condition in the regularization off and is a function reflecting sparse information of the estimated data. This function has the effect of smoothing or stabilizing the estimated data. The regularization term can be expressed by, for example, discrete cosine transform (DCT), wavelet transform, Fourier transform, or total variation (TV) off. For example, when the total variation is used, the estimated data can be obtained in a stable state in which an influence of noise of the observed data g is suppressed. Sparsity of the target 70 in a space of the regularization term is different depending on texture of the target 70. The regularization term may be selected such that the texture of the target 70 becomes sparser in the space of the regularization term. Alternatively, regularization terms may be included in the arithmetic operation. τ is a weight coefficient. As the weight coefficient τ increases, a reduction amount of redundant data increases and a compression rate increases. As the weight coefficient τ decreases, convergence to the solution weakens. The weight coefficient τ is set to an appropriate value at which f is converged to some extent without causing over-compression.

In the configurations of FIGS. 3B and 3C, the image encoded by the filter array 110 is formed in a blurred state on the imaging surface of the image sensor 160. Accordingly, the hyperspectral image 20 can be reconstructed by previously keeping the blur information and by reflecting the blur information on the above-mentioned matrix H. Here, the blur information can be expressed by a Point Spread Function (PSF). The PSF is a function specifying an extent of spread of a point image to surrounding pixels. For example, when a point image corresponding to one pixel on the image spreads to a region of (k×k) pixels around the one pixel due to the blurring, the PSF can be specified as a group of coefficients, namely a matrix, indicating influences on brightness of individual pixels in that region. The hyperspectral image 20 can be reconstructed by reflecting, on the matrix H, the influences of the blurring of an encoding pattern, those influences being expressed by the PSF. While the filter array 110 can be disposed at any desired position, the position may be selected such that the encoding pattern of the filter array 110 does not disappear due to excessive diffusion.

With the above-described processing, the hyperspectral image 20, namely the hyperspectral data cube, can be generated by decoding from the compressed image 10 obtained from the image sensor 160. The calculation of the above-described equation (2) is similar to that disclosed in U.S. Pat. No. 9,599,511. In U.S. Pat. No. 9,599,511, the same matrix H is used in the encoding and the decoding with respect to the equation (2). On the other hand, in this embodiment, matrixes different in at least parts thereof are used in the encoding and the decoding. Thus, as described later, the hyperspectral image can be altered in a manner of, for example, applying a desired identifier to the hyperspectral image generated by decoding.

### Inspection System

An example of an inspection system utilizing the above-described imaging system will be described below.

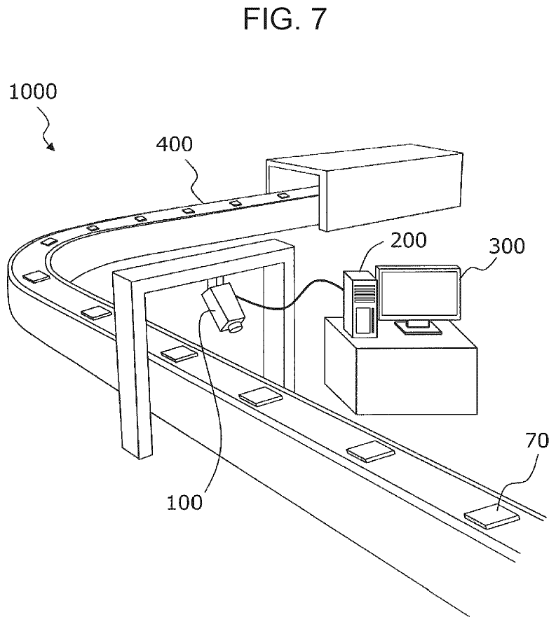

FIG. 7 illustrates an example of configuration of the inspection system 1000 according to this embodiment. The inspection system 1000 includes the imaging device 100, the processing device 200, a display device 300, and a conveyor 400. The display device 300 in the example illustrated in FIG. 7 is a display. Another type of device, such as a speaker or a lamp, may be disposed instead of or in addition to the display. The conveyor 400 is a belt conveyor. A picking device for removing the target 70 that has been found to be abnormal may also be disposed in addition to the belt conveyor.

The target 70 to be inspected is placed on a belt of the conveyor 400 and conveyed. The target 70 is any desired article, for example, an industrial produce or food. The inspection system 1000 obtains a hyperspectral image of the target 70 and detects a foreign matter mixed in the target 70 based on the obtained image information. The foreign matter to be detected may be any substance, for example, a particular metal, plastic, insect, trash, or hair. The foreign matter is not limited to such a substance and may be part of the target 70 where quality has degraded. For example, when the target 70 is food, rotten part of the food may be detected as the foreign matter. When the inspection system 1000 detects the foreign matter, it can output information indicating the detection of the foreign matter to an output device, for example, the display device 300 or the speaker, or can remove the target 70 including the foreign matter by the picking device.

The imaging device 100 is a camera capable of taking the above-described hyperspectral image. The imaging device 100 generates the above-described compressed image by taking an image of each of the targets 70 successively running on the conveyor. The processing device 200 is any suitable computer such as a personal computer, a server computer, or a laptop computer. The processing device 200 executes the decoding process in accordance with the above-described formula (2) based on the compressed image generated by the imaging device 100, thereby generating a decoded image for each of bands. The processing device 200 detects the foreign matter or an anomaly included in the target 70 based on the image for each band and outputs a detection result to the display device 300.

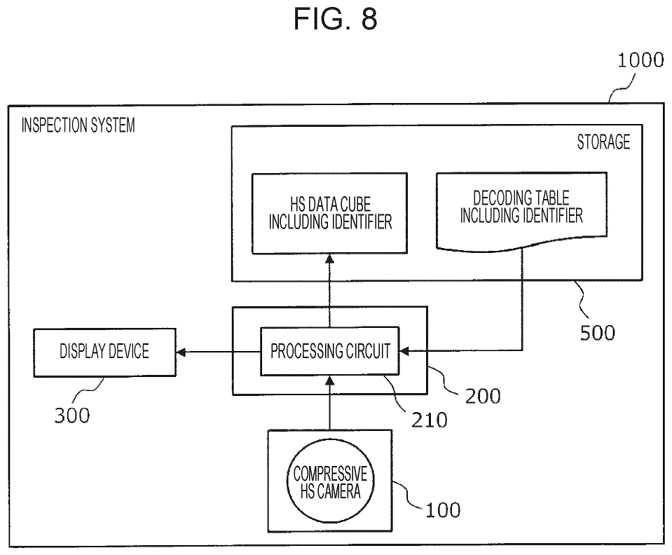

FIG. 8 is a block diagram illustrating an example of configuration related to data processing in the inspection system 1000. The inspection system 1000 includes, as components related to the data processing, the imaging device 100, the processing device 200, the display device 300, and a storage 500.

As described above with reference to FIGS. 3A to 3D, the imaging device 100 is the compressive HS camera including the image sensor, the filter array, and the optical system including the lens and so on. The imaging device 100 generates data of the compressed image in which items of multiband image information obtained by taking an image of the target 70 are superimposed and sends the generated data to the processing device 200.

The processing device 200 generates an image for each band based on the compressed image generated by the imaging device 100. The processing device 200 includes a processing circuit 210. The processing circuit 210 includes, for example, a processor such as a CPU (Central Processing Unit) or a GPU (Graphics Processing Unit). The processing circuit 210 determines, based on the compressed image generated by the imaging device 100, whether the particular foreign matter is included in the target 70 and outputs information indicating a determination result.

The storage 500 includes any suitable storage medium such as a semiconductor memory, a magnetic storage, or an optical storage. The storage 500 stores computer programs executed by the processing circuit 210, data used by the processing circuit 210 in processing processes, and data generated by the processing circuit 210 in the processing processes. The storage 500 further includes, for example, data of the compressed image generated by the imaging device 100, the decoding table that is the matrix data representing the decoding matrix, the HS data cube generated through decoding by the processing circuit 210, and data indicating the result of determining the presence of the foreign matter. Of those data, the decoding table and the HS data cube are illustrated, by way of example, in FIG. 8. In this embodiment, those data include information of the identifier. The identifier may be ID information specific to each imaging device 100 (namely, each camera). The decoding table is edited in accordance with the specifics of the identifier. As a result of using the decoding table edited, the identifier is included in the HS data cube after the decoding. The camera having been used to take the image can be specified based on the identifier.

In the following description, the decoding table edited to generate the data cube including the identifier 22 is expressed as the “decoding table including the identifier” in some cases for convenience. Similarly, in a later-described embodiment in which the encoding table is edited, the encoding table edited to generate the compressed image and the data cube each including the identifier is expressed as the “encoding table including the identifier” in some cases for convenience.

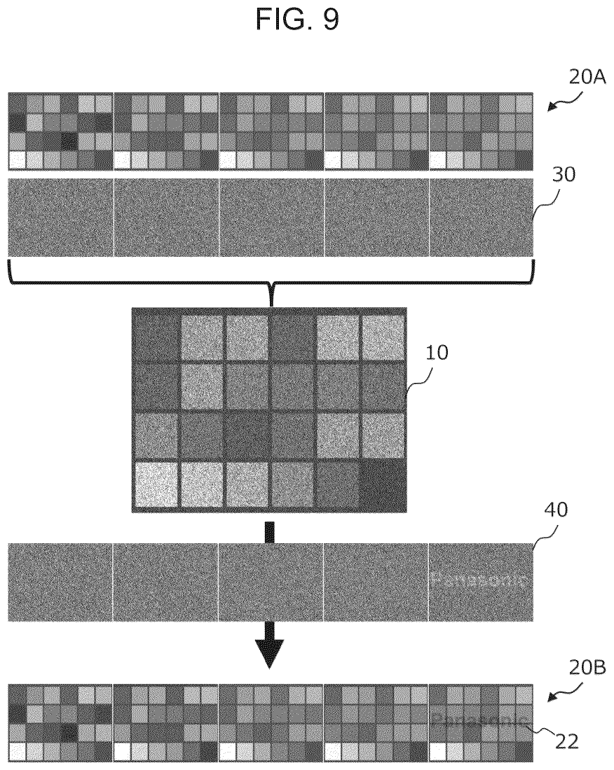

FIG. 9 is an explanatory view of an identifier insertion process in this embodiment. While a Macbeth color checker is used as the subject in the example illustrated in FIG. 9, the actual subject is the target to be inspected. Spectral information of a HS data cube 20A into which the identifier is not inserted is encoded by the encoding element (namely, the above-mentioned filter array 110) corresponding to the encoding table 30, and the compressed image 10 into which the identifier 22 is not inserted is recorded. In this embodiment, image compression is performed in a hardware way by the encoding element in the imaging device 100, and the compressed image 10 is generated by the image sensor. As in the example disclosed in Japanese Unexamined Patent Application Publication (Translation of PCT Application) No. 2020-508623, the compressed image 10 can also be generated by compressing a previously generated HS data cube in a software way. To generate a HS data cube 20B by decoding from the compressed image 10, the processing circuit 210 executes a decoding process by using the decoding table 40 of which part is altered in comparison with the encoding table 30. As a result, the altered part is transferred to a decoded image in part of the HS data cube 20B after the decoding, and the HS data cube 20B into which the identifier 22 is inserted can be generated.

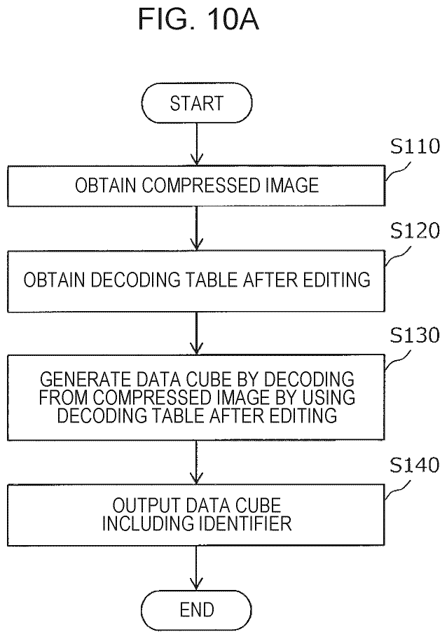

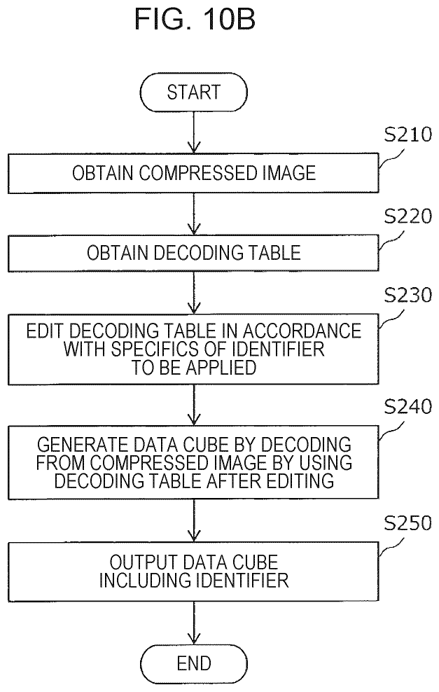

FIG. 10A is a flowchart illustrating processing in the processing circuit 210. First, the processing circuit 210 obtains the compressed image 10 generated by the imaging device 100 (step S110). The processing circuit 210 obtains the decoding table 40 after editing which is recorded in the storage 500 (step S120). The order of the step S110 and the step S120 may be reversed. Then, the processing circuit 210 generates the HS data cube 20B by decoding from the compressed image 10 by using the decoding table 40 after the editing (step S130). This decoding process is executed in accordance with, for example, the above-described formula (2). As a result, the HS data cube 20B including the identifier 22 is generated. The processing circuit 210 outputs the generated HS data cube 20B including the identifier 22 to the storage 500 to be stored therein (step S140).

In this embodiment, the decoding table 40 after the editing is generated in advance and is stored in the storage 500. The present disclosure is not limited to that embodiment, and the processing circuit 210 may edit the decoding table 40 in accordance with the identifier.

FIG. 10B is a flowchart illustrating an example of a process in which the processing circuit 210 edits the decoding table 40 in accordance with the identifier. In this example, the processing circuit 210 first obtains the compressed image 10 generated by the imaging device 100 (step S210). The processing circuit 210 obtains a decoding table before editing from the storage 500 (step S220). The decoding table before the editing is the same as the encoding table and is previously stored in the storage 500. Then, the processing circuit 210 edits the decoding table in accordance with the specifics of the identifier to be applied (S230). For example, as described above with reference to FIG. 2A, the decoding table is edited by rewriting a value in one or more partial regions of the decoding table, such as by multiplying the value by a constant. The processing circuit 210 outputs the decoding table after the editing to the storage 500 to be stored therein. The processes in the steps S220 and S230 may be executed prior to the step S210. Then, the processing circuit 210 generates the HS data cube 20B by decoding from the compressed image 10 by using the decoding table after the editing (step S240). This decoding process is executed in accordance with, for example, the above-described formula (2). As a result, the HS data cube 20B including the identifier 22 is generated. The processing circuit 210 outputs the generated HS data cube 20B including the identifier 22 to the storage 500 to be stored therein (step S250).

As described above, the processing circuit 210 in this embodiment generates the HS data cube 20B by decoding while inserting the identifier. In the process from the start of image-taking by the imaging device 100 to the process executed by the processing circuit 210, data is present only in a state in which the spectral information is compressed as the compressed image 10. Furthermore, after the process executed by the processing circuit 210, the data is present as the HS data cube 20B into which the identifier 22 is inserted. Thus, in this embodiment, the HS data cube into which the identifier 22 is not inserted does not exist in any processes. Accordingly, data safety can be kept high.

In the related art, the identifier is inserted after decoding the compressed image into the HS data cube. In such an identifier insertion process, because processing to generate the HS data cube and processing to insert the identifier are separated from each other, there is a state in which the HS data cube not including the inserted identifier exists. When a processing circuit to generate the HS data cube and a processing circuit to insert the identifier are separated from each other, the HS data cube to which the identifier is not inserted is transferred, thus causing a state in which the data safety is not ensured.

According to this embodiment, since the HS data cube to which the identifier is not inserted is not generated, the data safety can be increased. Moreover, the process of obtaining the HS data cube and the process of inserting the identifier can be unified by using the technique of this embodiment. Therefore, a data processing load can be reduced in comparison with that in the related-art identifier insertion technique, and hence the HS data cube including the identifier can be generated with a simpler circuit configuration.

While the identifier is applied to the HS data cube in this embodiment, the HS data cube may be altered in another way. For example, as illustrated in FIG. 2B, the random noise may be applied to the decoding table such that the original HS data cube is made difficult to read. Alternatively, as illustrated in FIG. 2C, the dynamic range of the HS data cube may be increased or decreased by uniformly multiplying each matrix element of the decoding table by a constant. Those modifications can also be similarly applied to other embodiments described below.

### SECOND EMBODIMENT

A second embodiment of the present disclosure will be described below. The second embodiment is different from the first embodiment in that, instead of the decoding table, the encoding table is edited in accordance with the identifier. The following description is made mainly about a point different from the first embodiment, and description of common matters is omitted.

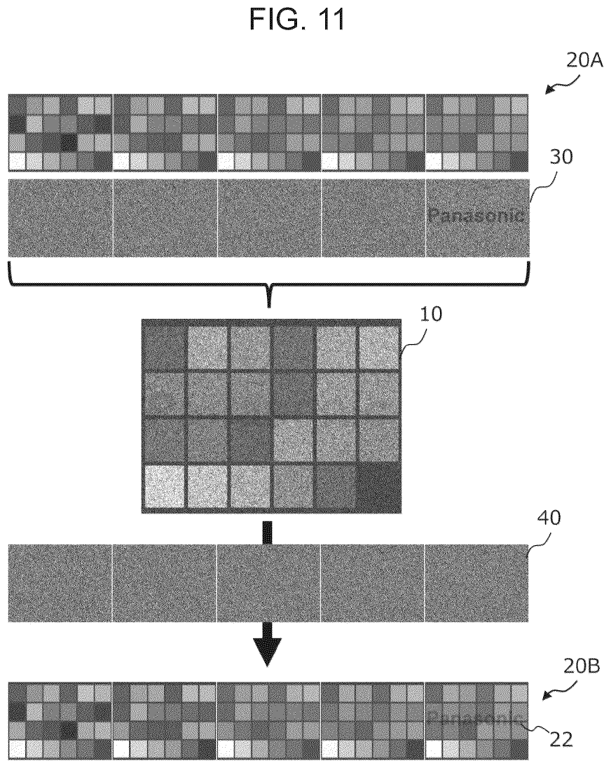

FIG. 11 is an explanatory view of an identifier insertion process in this embodiment. In this embodiment, the spectral information of the HS data cube 20A into which the identifier is not inserted is encoded by the encoding table 30 including the identifier information or the encoding element corresponding to the encoding table 30. Thus, the compressed image 10 into which the identifier information is inserted is recorded. The compression by the encoding may be performed in a hardware way or a software way. In the examples illustrated in FIGS. 3A to 3D, the compression is performed in a hardware way by using the encoding element. In that case, it is possible to use a configuration that a filter reflecting or absorbing only light in a particular one among wavelength bands included in the target wavelength range is disposed only in a partial region corresponding to a position of the identifier in the filter array 110. With such a configuration, the compressed image 10 including the identifier information can be obtained. Alternatively, as in the device disclosed in Japanese Unexamined Patent Application Publication (Translation of PCT Application) No. 2020-508623, the compressed image 10 may be generated in a software way. In that case, any desired identifier information can be inserted into the encoding table 30 by software processing. The decoding process is executed based on the compressed image 10 in which the identifier information and the spectral information are compressed as described above. In the decoding process, the decoding table 40 in which the identifier information is removed from the encoding table 30 (namely, the decoding table into which the identifier information is not inserted) is used. That decoding table 40 is the same as the original encoding table. Since the decoding table 40 not including the identifier information is used, the altered part of the encoding table is transferred to a decoded image in part of the bands of the HS data cube 20B. As a result, the HS data cube 20B into which the identifier is inserted can be generated.

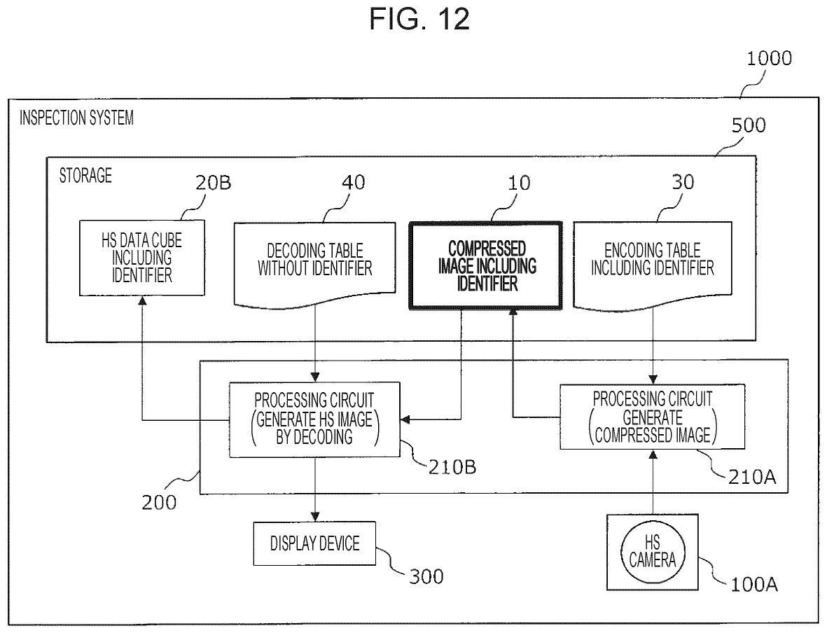

FIG. 12 is an explanatory block diagram of the identifier insertion process in this embodiment. In the example of FIG. 12, any suitable HS camera can be used as an imaging device 100A. The processing device 200 in this example includes a first processing circuit 210A that generates the compressed image and a second processing circuit 210B that generates the HS data cube by decoding. The first processing circuit 210A generates the compressed image 10 including the identifier information by compressing the HS data cube, generated by the imaging device 100A, with the encoding table 30 into which the identifier information is inserted. The first processing circuit 210A outputs the generated compressed image 10 to the storage 500 to be stored therein. The second processing circuit 210B obtains, from the storage 500, both the compressed image 10 into which the identifier 22 is inserted and the decoding table 40 into which the identifier is not inserted, and executes the decoding process in accordance with the above-described formula (2). With that decoding process, the second processing circuit 210B generates the HS data cube 20B into which the identifier is inserted. The second processing circuit 210B stores the generated HS data cube 20B including the identifier in the storage 500.

In the series of processes illustrated in FIG. 12, the HS data cube exists in a state not including the identifier only in a section where the HS data cube is sent from the imaging device 100A that is the HS camera. In the processes subsequent to the above-mentioned section, however, the data always exists in the state including the identifier. Accordingly, the vulnerability of data can be overcome.

In the related art, the HS data cube obtained by any suitable HS camera is compressed by using the encoding table into which the identifier information is not inserted, and the identifier is inserted after decoding. The compressed image is recorded in the state not including the inserted identifier. The compressed image is processed by using the decoding table that is the same as the encoding table used in the compression. As a result, the HS data cube into which the identifier is not inserted is generated by decoding. After the decoding into the HS data cube, the identifier is inserted into the obtained HS data cube. In the above-mentioned series of processes, the HS data cube into which the identifier is not inserted is generated and transferred during a period from the decoding into the HS data cube to the insertion of the identifier. This causes a problem of data security. If the identifier is inserted in a stage prior to the process of generating the compressed image in an identifier insertion method according to the related art, the HS data cube into which the identifier is not inserted is moved only in the process of sending the HS data cube from the HS camera. In that case, a risk of data security is similar to that in this embodiment. but more processing processes are required than in this embodiment, and the cost necessary for the data processing is increased.

### THIRD EMBODIMENT

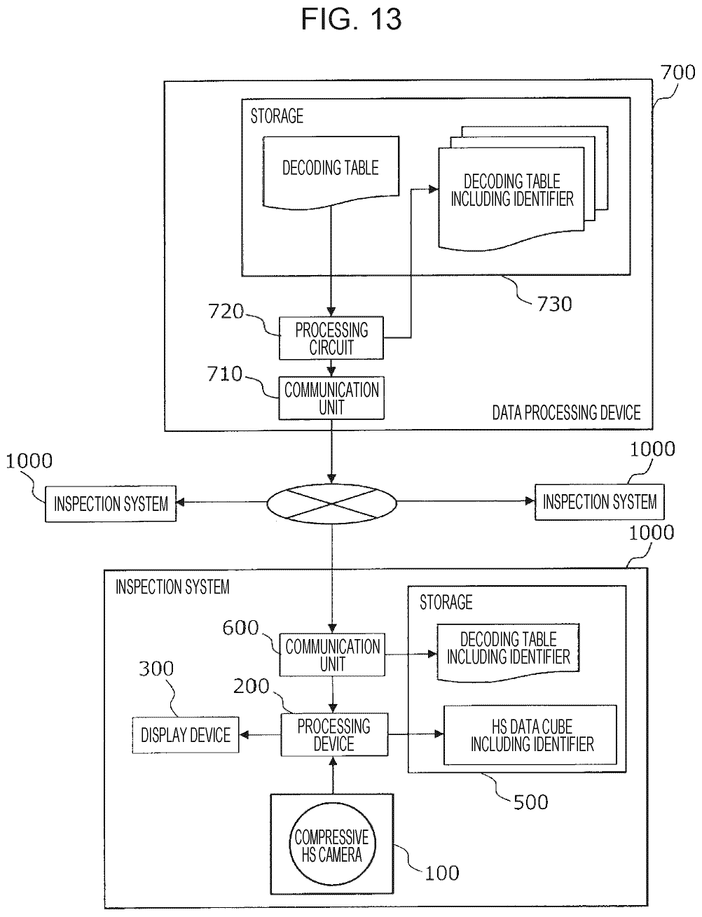

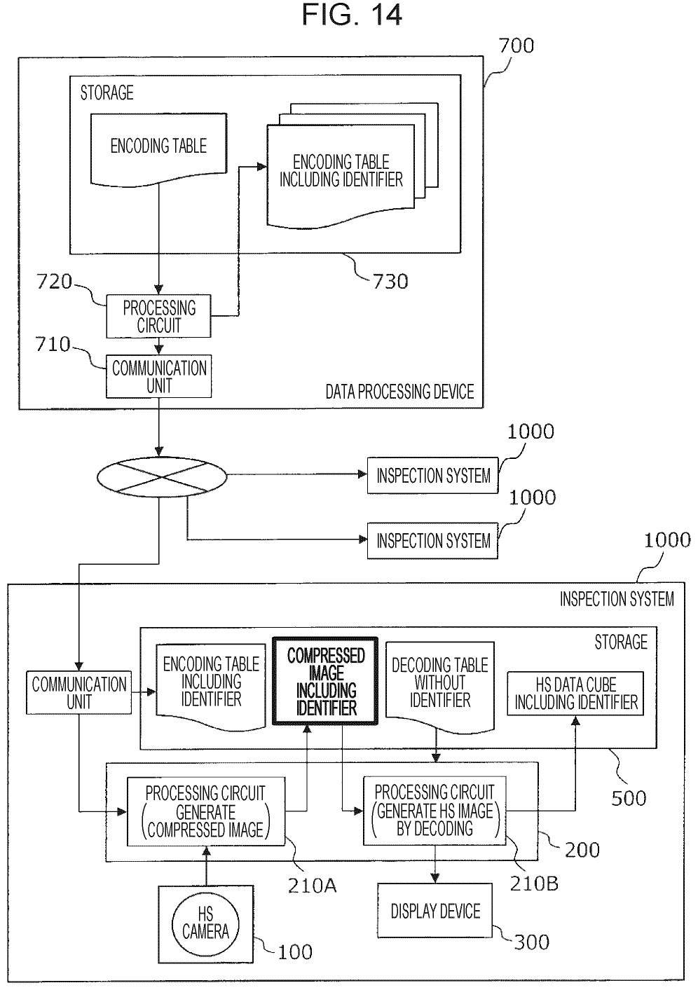

FIG. 13 is a block diagram illustrating a configuration of a system according to a third embodiment of the present disclosure. The system according to this embodiment includes a data processing device 700 and one or more inspection systems 1000. While FIG. 13 illustrates, by way of example, three inspection systems 1000, the number of inspection systems 1000 is optional. Each of the inspection systems 1000 includes similar components to those in the inspection system 1000 according to the first embodiment. However, each inspection system 1000 in this embodiment additionally includes a communication unit 600 for communicating with the data processing device 700. The data processing device 700 is a computer that delivers necessary information to each inspection system 1000. The data processing device 700 may be, for example, a server computer possessed by the maker of the imaging device 100. The data processing device 700 can communicate with each inspection system 1000 via a network, for example, the Internet. The data processing device 700 includes a communication unit 710, a processing circuit 720, and a storage 730. The communication unit 710 is a circuit for communicating with the communication unit 600 in each inspection system 1000. The processing circuit 720 includes a processor that generates the decoding table including the identifier information. The storage 730 stores programs executed by the processing circuit 720 and various data, such as the decoding table that is referenced by the processing circuit 720 in a processing process and the decoding table that is generated by the processing circuit 720 and that includes the identifier information.

The processing circuit 720 edits the decoding table, recorded in the storage 730, in accordance with the specifics of the identifier to be inserted into the HS data cube, thereby generating the decoding table including the identifier information, and records the generated decoding table in the storage 730. The processing circuit 720 delivers the generated decoding table including the identifier information to the inspection system 1000. The communication unit 600 in the inspection system 1000 records the received decoding table including the identifier in the storage 500. The processing device 200 generates the HS data cube including the identifier based on both the delivered decoding table and the compressed image generated by the imaging device 100, and records the generated HS data cube in the storage 500. Processing executed by the processing device 200 is similar to the processing described in the first embodiment with reference to FIG. 10A.

The data processing device 700 may deliver a different identifier for each of the inspection systems 1000. By changing the identifier regularly or irregularly, the data processing device 700 can identify or track the device used for the decoding or the date and time of the execution of the decoding.

### FOURTH EMBODIMENT

FIG. 14 is a block diagram illustrating a configuration of a system according to a fourth embodiment of the present disclosure. The system according to this embodiment includes a data processing device 700 and inspection systems 1000. This embodiment is different from the third embodiment in that a processing circuit 720 in the data processing device 700 edits the encoding table instead of the decoding table in accordance with the specifics of the identifier, and that a processing device 200 in each of the inspection systems 1000 generates the compressed image including the identifier by using the edited encoding table. The processing device 200 in each inspection system 1000 executes a similar operation to that of the processing device 200 in the second embodiment.

The processing circuit 720 in the data processing device 700 according to this embodiment edits the encoding table, recorded in the storage 730, in accordance with the specifics of the identifier to be inserted into the HS data cube, thereby generating the encoding table including the identifier information, and records the generated encoding table in the storage 730. The processing circuit 720 delivers the generated encoding table including the identifier information to the inspection system 1000. The communication unit 600 in the inspection system 1000 records the received encoding table including the identifier in the storage 500. The processing device 200 includes a first processing circuit 210A and a second processing circuit 210B as in the second embodiment. The first processing circuit 210A generates the compressed image including the identifier by encoding the hyperspectral data cube, generated by the imaging device 100, with the encoding table delivered from the data processing device 700 and including the identifier. The first processing circuit 210A outputs the generated compressed image including the identifier to the storage 500 to be stored therein. The second processing circuit 210B obtains, from the storage 500, the compressed image including the identifier and the decoding table not including the identifier, generates the HS data cube including the identifier 22 based on both the obtained data, and records the generated HS data cube in the storage 500.

In this embodiment as well, the data processing device 700 may deliver a different identifier for each of the inspection systems 1000. By changing the identifier regularly or irregularly, the data processing device 700 can identify or track the device used for the decoding or the date and time of the execution of the decoding.

### FIFTH EMBODIMENT

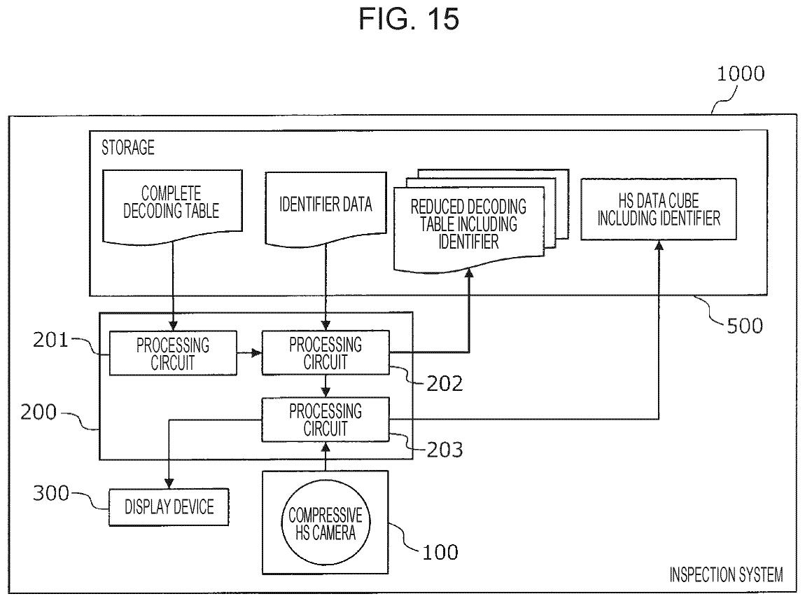

FIG. 15 is a block diagram illustrating a configuration of an inspection system 1000 according to a fifth embodiment of the present disclosure. The inspection system 1000 in this embodiment includes a similar hardware configuration to that in the first embodiment. The processing device 200 in this embodiment partially combines the wavelength bands included in the target wavelength range and executes decoding after rearrangement into a smaller number of bands. In the following description, a decoding table for generating an image by decoding for each of the wavelength bands included in the target wavelength range is referred to as a “complete decoding table”. A decoding table for generating an image by decoding for each of new wavelength bands in which the wavelength bands included in the target wavelength range are partially unified into individual one combined band is referred to as a “reduced decoding table”. The reduced decoding table has a smaller data size than the complete decoding table. Because of generating and utilizing the reduced decoding table, the calculation cost for the decoding process can be reduced. For example, by unifying, into one band, successive bands that are not important in inspection, a load of the calculation process can be reduced without deteriorating accuracy of the inspection. The processing device 200 in this embodiment generates the reduced decoding table based on the complete decoding table. At that time, the reduced decoding table including the information corresponding to the identifier to be inserted into the HS data cube is generated. The processing device 200 includes three processing circuits 201, 202, and 203. The processing circuit 201 generates the reduced decoding table by executing a process of combining partial bands based on the complete decoding table. For example, by executing a process of averaging values of two or more elements corresponding to two or more successive bands in the complete decoding table, those elements are unified into one element. With the above-mentioned process, the reduced decoding table having a relatively compressed size in comparison with the complete decoding table is generated. The processing circuit 202 adds the identifier information to the reduced decoding table. For example, the identifier information is embedded into the reduced decoding table by a method of multiplying values of partial regions in the reduced decoding table by a constant. The processing circuit 203 generates the HS data cube including the identifier based on both the compressed image generated by the imaging device 100 and not including the identifier and the reduced decoding table generated by the processing circuit 202 and including the identifier information. The generated HS data cube is recorded in the storage 500. The processing circuit 203 may display the decoded image in each band on the display device 300. The order of the band combining process executed by the processing circuit 201 and the identifier insertion process executed by the processing circuit 202 may be exchanged.

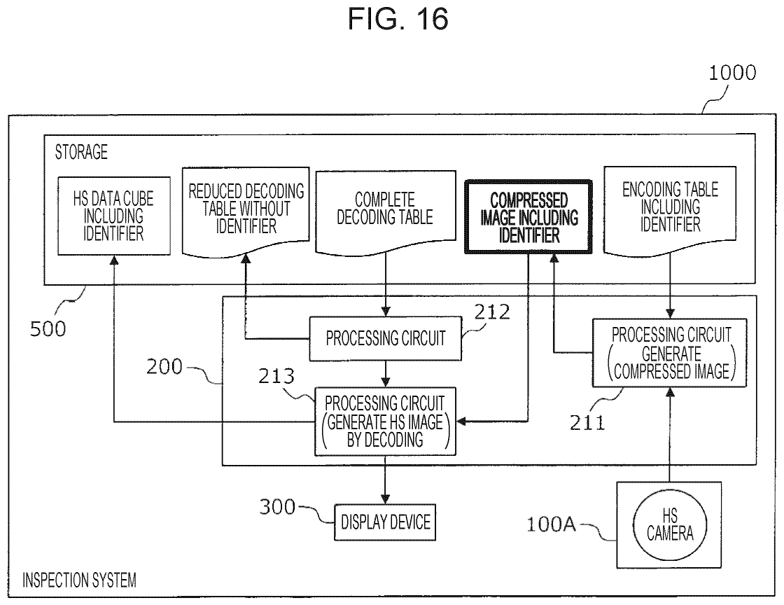

FIG. 16 is a block diagram illustrating a modification of the inspection system 1000 according to this embodiment. The inspection system 1000 according to the modification has a similar hardware configuration to that of the inspection system 1000 according to the second embodiment. The processing device 200 according to the modification includes processing circuits 211, 212, and 213. The processing circuit 211 generates the compressed image including the identifier information by encoding the HS data cube, generated by the imaging device 100A, with the encoding table including the identifier information and recorded in the storage 500, and records the generated compressed image in the storage 500. The processing circuit 212 obtains the complete decoding table from the storage 500, generates the reduced decoding table by unifying information in partial bands, and records the generated reduced decoding table in the storage 500. The reduced decoding table in this modification does not include the identifier information. The processing circuit 213 generates the HS data cube including the identifier based on both the compressed image generated by the processing circuit 211 and including the identifier information and the reduced decoding table generated by the processing circuit 212 and not including the identifier information. The processing circuit 213 records the generated HS data cube in the storage 500 and displays an image in each band on the display device 300. The above-described operation can also generate the HS data cube including the identifier.

In any of the examples of FIGS. 15 and 16, in the process of generating the reduced decoding table, bands to be combined may be determined by referring to a statistic learning model or the like that is generated in advance by utilizing, for example, mechanical learning.

### SIXTH EMBODIMENT

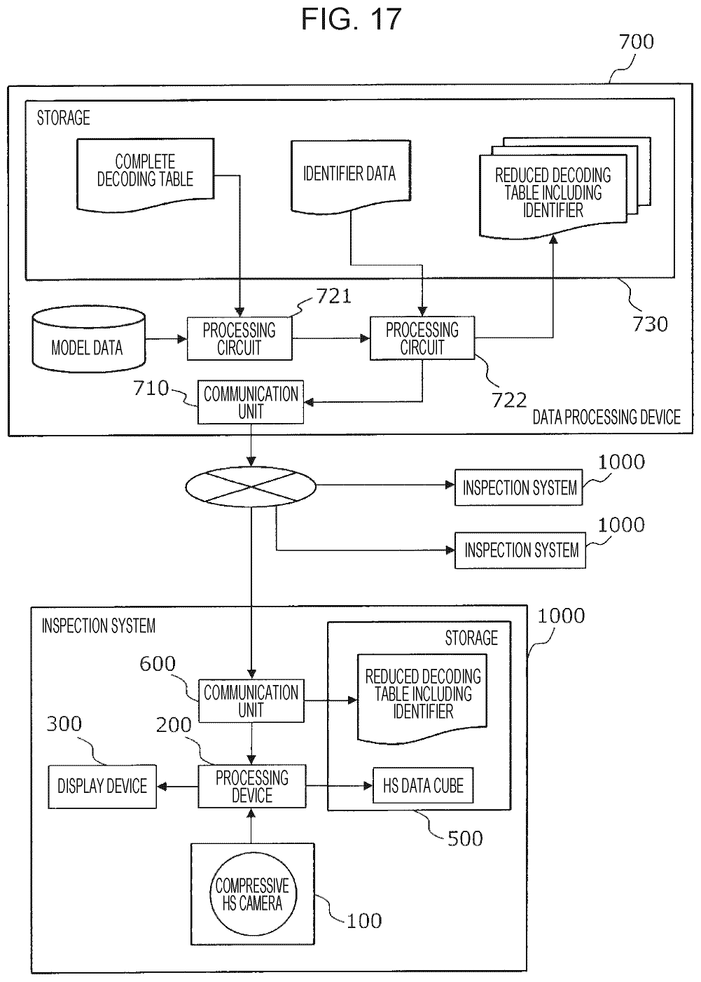

FIG. 17 is a block diagram illustrating a configuration of a system according to a sixth embodiment of the present disclosure. The system according to this embodiment includes a data processing device 700 and inspection systems 1000 as in the third embodiment. Each of the inspection systems 1000 has a similar configuration to that in the third embodiment. The system of this embodiment is different from the system of the third embodiment in that the data processing device 700 generates a reduced decoding table from a complete decoding table, adds data of the identifier to the generated reduced decoding table, and delivers the reduced decoding table including the identifier to each inspection system 1000. The data processing device 700 in this embodiment includes two processing circuits 721 and 722. The processing circuit 721 obtains the complete decoding table recorded in the storage 730 and generates the reduced decoding table in which items of information in two or more successive wavelength bands with relatively low importance in the complete decoding table are combined. In the above-described process, the processing circuit 721 generates the reduced decoding table in accordance with model data. The model data includes data of, for example, a statistic model with a principal component analysis or a nonlinear model such as a neural network, the data including a weight for each wavelength band as a parameter, and is generated from a lot of learning data. The processing circuit 722 generates another reduced decoding table by adding the identifier information to the reduced decoding table generated by the processing circuit 721 and stores the other reduced decoding table in the storage 730. The process of generating the reduced decoding table by the processing circuit 721 and the process of inserting the identifier by the processing circuit 722 may be executed in reverse order.

### SEVENTH EMBODIMENT

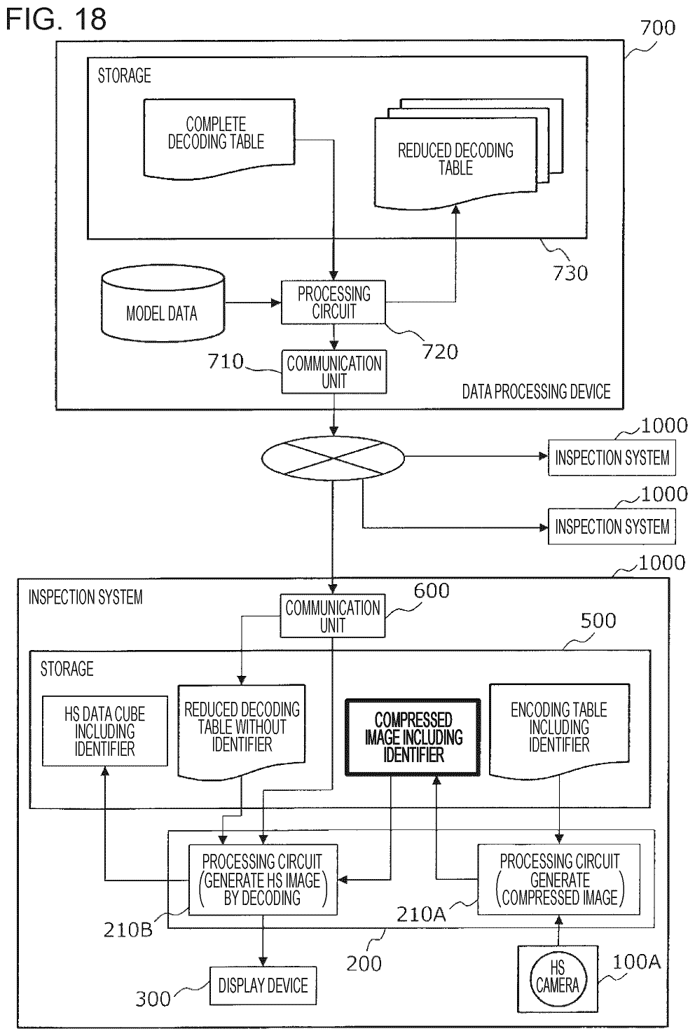

FIG. 18 is a block diagram illustrating a configuration of a system according to a seventh embodiment of the present disclosure. The system according to this embodiment also includes a data processing device 700 and inspection systems 1000. Each of the inspection systems 1000 has a similar configuration to that in the fourth embodiment. In this embodiment, the data processing device 700 generates a reduced decoding table from a complete decoding table and delivers the reduced decoding table to each inspection system 1000. The encoding table including the identifier information is previously recorded in the storage 500. As in the fourth embodiment, the data processing device 700 may generate the encoding table including the identifier information and may deliver the generated encoding table to the inspection system 1000.

A processing circuit 720 in this embodiment generates the reduced decoding table based on both the complete decoding table recorded in the storage 730 and model learning data that is prepared in advance. The reduced decoding table does not include the identifier information. The processing circuit 720 delivers the generated reduced decoding table to the inspection system 1000.

The processing device 200 in the inspection system 1000 includes a processing circuit 210A and a processing circuit 210B as in the example of FIG. 14. The processing circuit 210A encodes the HS data cube, generated by the imaging device 100A, with the encoding table recorded in the storage 500 and including the identifier information. As a result, the compressed image including the identifier information is generated. The processing circuit 210B generates the HS data cube including the identifier by decoding from the compressed image by using the reduced decoding table delivered from the data processing device 700 and not including the identifier information. The HS data cube after the decoding is recorded in the storage 500, and an image in each band is displayed on the display device 300.

The technique of the present disclosure is useful in, for example, a camera and a measuring device each taking a multiwavelength image. The technique of the present disclosure can be used in, for example, applications for detecting foreign matters mixed in articles such as industrial products or foods.

What is claimed is:

1. A method executed by a computer, the method comprising:
obtaining matrix data representing an encoding matrix used to encode a spectral data cube including image information in wavelength bands and to generate a compressed image and/or a decoding matrix used to generate the spectral data cube by decoding from the encoded compressed image;
editing the matrix data in a way of causing the image information in at least one of the wavelength bands in the spectral data cube to be altered in the spectral data cube after being generated by decoding; and
outputting the matrix data after the editing.

2. The method according to claim 1, wherein editing the matrix data includes rewriting the matrix data such that the image information in the at least one wavelength band includes an identifier in the spectral data cube after being generated by decoding.

3. The method according to claim 1, wherein editing the matrix data includes rewriting the matrix data such that noise hindering read of the image information in the at least one wavelength band is applied to the spectral data cube.

4. The method according to claim 1, wherein editing the matrix data includes rewriting the matrix data such that at least one of a gradation and a resolution of the image information in the at least one wavelength band is changed.

5. The method according to claim 1, wherein editing the matrix data includes rewriting the matrix data in a way of causing the image information in the wavelength bands in the spectral data cube to be altered in the spectral data cube after being generated by decoding.

6. The method according to claim 1, wherein the matrix data represents the decoding matrix.

7. The method according to claim 6, wherein outputting the matrix data after the editing includes transmitting the matrix data to a device that generates the spectral data cube by decoding from the compressed image based on the matrix data representing the decoding matrix.

8. The method according to claim 6, wherein outputting the matrix data includes storing the matrix data representing the decoding matrix in a storage medium, and
wherein the method further comprises:
obtaining the compressed image; and
generating the spectral data cube by decoding from the compressed image by using the matrix data after the editing.

9. The method according to claim 1, wherein the compressed image is generated by an imaging device including a filter array,
the filter array includes multiple types of optical filters with transmission spectra different from one another,
the encoding matrix corresponds to a two-dimensional distribution of the transmission spectra of the filter array, and
generating the spectral data cube by decoding includes generating the spectral data cube by decoding from the compressed image with a compressed sensing process based on the decoding matrix.

10. The method according to claim 1, wherein the matrix data represents the encoding matrix.

11. The method according to claim 10, wherein outputting the matrix data includes transmitting the matrix data to a device that generates the compressed image by encoding the spectral data cube based on the matrix data representing the encoding matrix.

12. The method according to claim 10, wherein outputting the matrix data after the editing includes storing the matrix data representing the encoding matrix in a storage medium, and
wherein the method further comprises:
obtaining the spectral data cube; and
generating the compressed image by encoding the spectral data cube based on the matrix data after the editing.

13. The method according to claim 2, wherein the identifier includes information specifying a device that generates the compressed image based on the encoding matrix, or a device that generates the spectral data cube by decoding based on the decoding matrix.

14. The method according to claim 2, wherein the identifier includes information specifying a date and time of application of the identifier.

15. The method according to claim 1, wherein obtaining the matrix data includes:
obtaining a decoding table to generate an image by decoding from the compressed image for each of wavelength bands included in a target wavelength range; and
generating, based on the decoding table, as the matrix data representing the decoding matrix, a reduced decoding table in which two or more wavelength bands among the wavelength bands are unified into one wavelength band and which is used to generate, as the spectral data cube, an image by decoding for each of a smaller number of the wavelength bands than all the wavelength bands, and
editing the matrix data includes editing the reduced decoding table.

16. The method according to claim 15, wherein outputting the matrix data after the editing includes transmitting the reduced decoding table after the editing to another device.

17. The method according to claim 1, wherein the matrix data includes first matrix data representing the encoding matrix and second matrix data representing the decoding matrix, and
editing the matrix data includes editing the first matrix data and the second matrix data.

18. A device comprising:
a storage that stores matrix data representing an encoding matrix used to encode a spectral data cube including image information in wavelength bands and to generate a compressed image and/or a decoding matrix used to generate the spectral data cube by decoding from the encoded compressed image; and
a processing circuit that edits the matrix data in a way of causing the image information in at least one of the wavelength bands in the spectral data cube to be altered in the spectral data cube after being generated by decoding, and that outputs the matrix data after the editing.

19. A device comprising a storage that stores the matrix data after the editing, the matrix data being output from the device according to claim 18, and
a processing circuit that executes a process of encoding the spectral data cube based on the matrix data and generating the compressed image and/or a process of generating the spectral data cube by decoding from the compressed image based on the matrix data.

20. The device according to claim 19,
wherein the matrix data represents the decoding matrix,
the device further comprises an imaging device that generates the compressed image, and
the processing circuit generate the spectral data cube by decoding from the compressed image based on the matrix data representing the decoding matrix.

21. The device according to claim 20,
wherein the imaging device comprises:
a filter array including multiple types of optical filters with transmission spectra different from one another; and
an image sensor that detects light transmitting through the filter array and generates the compressed image, and
wherein the encoding matrix corresponds to a two-dimensional distribution of the transmission spectra of the filter array.
